(19) United States
(12) Patent Application Publication
(10) Pub. No.: US 2011/0035264 A1
(43) Pub. Date: Feb. 10, 2011

(54) SYSTEM FOR COLLECTABLE MEDIUM

(76) Inventor: George B. Zaloom, Encino, CA (US)

Correspondence Address: LAW OFFICES OF KAMRAN FATTAHI, 15303 VENTURA BLVD., SUITE 1400, SHERMAN OAKS, CA, 91403, US

(21) Appl. No.: 12/849,703

(22) Filed: Aug. 3, 2010

Related U.S. Application Data
(60) Provisional application No. 61/231,308, filed on Aug. 4, 2009.

(51) Int. Cl. G06Q 30/00; G06F 17/30

(52) U.S. Cl. 705/14.12; 705/14.39; 707/802; 707/723; 707/E17.044

(57) ABSTRACT

An entertainment system, method, and computer program for social mapping in combination with a commercially purchased token, wherein the system allows a user to register the token online using a registration code, allowing the user access to various entertainment activities and scenarios in a “social network” via a computer connected to the Internet. A member registers the token online using a registration code; the data of which is then sent to an online database. The member of the network may then access various entertainment activities and scenarios associated with the token's registration code and connect with other members online.

### CROSS-REFERENCE TO RELATED APPLICATIONS

This Application claims the benefit of priority of the co-pending U.S. Utility Provisional Patent Application No. 61/231,308, filed 4 Aug. 2009, the entire disclosure of which is expressly incorporated by reference herein.

### INCORPORATION BY REFERENCE

All publications and patent applications mentioned in this specification are herein incorporated by reference to the same extent as if each individual publication or patent application was specifically and individually indicated to be incorporated by reference.

### BACKGROUND OF THE INVENTION

1. Field of the Invention

This application relates generally to a system, method and computer program for token collecting and social mapping.

2. Description of Related Art

Historically consumers purchase collectable trading cards and exchange them as a means of social interaction or gameplay. The most common form is the trading card (or collectible card), a small card, usually made out of cardboard or thick paper, which usually contains an image of a certain person (fictional or real) and a short description of the picture, along with other text (statistics or trivia). Trading cards are traditionally associated with sports; baseball cards are especially well-known, additionally there are other forms of cards that often feature cartoons, comic book or fantasy characters as the basis for gameplay.

Traditionally, the information and statistics contained on the trading card become quickly outdated (especially where sports statistics are concerned). Over time, the pictures fade and cards deteriorate. As the cards were small, there is usually only room to display one photograph of the subject. Collectors are also limited to trading cards with cohorts in their geographic region.

The advent of the Internet brought new challenges and opportunities for trading card collectors. With a personal computer connected to the internet, collectors could go online and check the up-to-the-minute stats of their favorite players. They could also watch streaming highlights of gameplay. Both of these were impossible to obtain from a cardboard trading card. The gravitation to the Internet by collectors, both young and old, also challenged the traditional person-to-person card exchanges.

However, regrettably, neither physical nor virtual cards provide the direct connection or relationship between an individual cohort and the collectable medium that the cohort has interest. Accordingly, there is need to provide a collectable medium that may be uniquely associated with an individual or cohort.

### BRIEF SUMMARY OF THE INVENTION

A method is provided for an offline and Internet based social token exchange network to a user for entertainment. The method comprises storing data relating to a plurality of registration codes, each of the registration codes corresponding to one of a plurality of tokens; serving content, via a communication network, to a user computer; receiving one of the registration codes transmitted from the user computer via one or both of the communication network and an additional communication network; verifying the one of the registration codes against the data relating to the plurality of registration codes; registering a token corresponding to the one of the registration codes after the verifying; and providing collector's data for including in the content.

Further provided is an entertainment system for providing an online entertainment and social networking of a user of a token. The system comprises: a server subsystem for serving content, via a communication network, to a user computer, and for receiving one or both of data and commands from the user computer; a registration subsystem for verifying and then registering the token, wherein the verifying includes determining a validity of the token, and wherein the registering is for allowing the user to access a restricted portion of the Entertainment System; and a online entertainment and social networking data for including in the content.

Also provided is a computer program for social mapping in combination with commercially purchased tokens and the generation of unique random codes associated with those tokens.

An optional exemplary aspect of the present invention provides a system for collectable medium, comprising:
a collectable medium with a unique identification; and
a collectable computer networking system that includes a database that identifies and associates the unique collectable medium exclusively with a specific user.

Another optional exemplary aspect of the present invention provides a system for collectable medium, wherein:
the collectable medium is one of a physical and virtual collectable medium.

Yet another optional exemplary aspect of the present invention provides a system for collectable medium, wherein:
the collectable medium, includes:
unique identification mechanism that exclusively identifies the collectable medium; and
content.

Still another optional exemplary aspect of the present invention provides a system for collectable medium, wherein:
the collectable medium includes physical characteristic commensurate with collectable interest.

A further optional exemplary aspect of the present invention provides a system for collectable medium, wherein:
the content includes:
media (non-limiting examples of which may include visual, audio, or others) related to a collectable interest (non-limiting examples of which may include stamps, popular individuals, or characters, or others);
media related to brand association and marketing,
statistical data related to the collectable interest;
Uniform Resource Locator (URL) of the system.

Yet a further optional exemplary aspect of the present invention provides a system for collectable medium, wherein:
the statistical data, includes:
information related to subject matter of collectable interest.

Still a further optional exemplary aspect of the present invention provides a system for collectable medium, wherein:
the collectable computer networking system is an online network of cohorts, which also includes individuals that posses collectable medium. Non-limiting exemplary definition of the term cohorts may be construed as entities, groups, or individuals with similar interests.

Another optional exemplary aspect of the present invention provides a system for collectable medium, wherein:
the cohorts associate the collectable medium with the collectable computer networking system by registration, including entry of the unique identification of the collectable medium within the system database.

Still another optional exemplary aspect of the present invention provides a system for collectable medium, wherein:
the collectable computer networking system provides incentives to register a collectable medium.

Yet another optional exemplary aspect of the present invention provides a system for collectable medium, wherein:
the collectable medium is assigned a set of redeemable points as incentive to acquire additional collectable medium, virtual collectables, and other items of interest.

Still another optional exemplary aspect of the present invention provides a system for collectable medium, wherein:
the collectable computer networking system, includes:
various navigational tools to enable a user to link and network with cohorts, including:
a collectable medium display section for displaying a set of collectable medium of a cohort;
a User Profile section link;
Roster Update section that provides updated information for the subject of interest;
a Favorites section that lists the favorite collectable medium by subject of interest;
a Ranking section for ranking cohorts collections and standing within the collectable computer networking system;
Network statistical sections for total number of online users and trades of the collectable medium;
a Real-Time Instant Messaging System for cohorts that are online, including an internal email system;
links to a wireless mobile system for additional connectivity;
Live News Ticker related to subject of interest;
Advertising section;
mechanism for invitation of non-registered users;
links to sources for the collectable medium; and
links to external URL.

A further optional exemplary aspect of the present invention provides a system for collectable medium, wherein:
a User Profile section includes:
an informational tote board that displays trading and acquisition of collectable medium within the collectable computer networking system by user and user cohorts; and
cohort affinity for subsets of collectable medium, and links that enable a user to access the cohort.

Yet a further optional exemplary aspect of the present invention provides a system for collectable medium, further includes:
a display of a subset of the collectable mediums of subject of interest, which facilitates the user to determine the completeness of the set;
includes a system message that promotes and incentivizes the addition of collectable medium to complete a full set;
navigational bar that enables users to navigate through the collectable computer networking system for addition and trade of collectable medium, including view of larger subsets of subject of interest and other cohorts with similar interests; and
the ranking subsection for ranking cohorts collections and standing within the collectable computer networking system for a particular set of collectable medium related to a specific subject of interest.

Another optional exemplary aspect of the present invention provides a system for collectable medium, wherein:
selection of an individual collectable medium from the subset of collectable medium displays further detailed information related to the selected individual collectable medium, including the unique identifier and content.

Yet another optional exemplary aspect of the present invention provides a system for collectable medium, further including:
a chain of title of ownership of the selected collectable medium, with individual cohorts within the chain of title optionally remaining private.

Still a further optional exemplary aspect of the present invention provides a system for collectable medium, further includes:
a fully integrated trading mechanism that enables users to post collectable medium for trading, including:
an audio-visual display of the collectable medium that enables a trader to informatively select and trade off collectable medium internally within the collectable computer networking system.

Another optional exemplary aspect of the present invention provides a system for collectable medium, further includes:
an alert mechanism notifying interested cohorts of a trade to participate in appraisal and trade of a particular collectable medium.

Still another optional exemplary aspect of the present invention provides a system for collectable medium, wherein:
the virtual collectables include:
amusement disrupters that are forwarded to cohorts for disrupting online viewing experience of a receiving cohort. Non-limiting examples of amusement disrupter may include any one or combinations of short videos, audios, images.

Yet another optional exemplary aspect of the present invention provides a system for collectable medium, wherein:
virtual collectable medium is a representation of a physical collectable article.

A further optional exemplary aspect of the present invention provides a system for collectable medium, wherein:
the collectable medium is provided to participating cohorts of an event by a sponsor to establish a relationship with cohorts.

Yet a further optional exemplary aspect of the present invention provides a system for collectable medium, wherein:
the established relationship is comprised of incentives for the cohorts to register the provided collectable medium with the collectable computer networking system, and attend further sponsored events to complete a set of the collectable medium.

Still a further optional exemplary aspect of the present invention provides a system for collectable medium, wherein:
the collectable medium is provided to individual as a purchase incentive by sponsors.

Another optional exemplary aspect of the present invention provides a system for collectable medium, wherein:
the collectable medium is purchased by an individual.

Another optional exemplary aspect of the present invention provides a system for collectable medium, wherein:
cohorts engage in online virtual games with rewards in terms of additional points that may be used within the system, with games themed around cohorts' affinities.

Such stated advantages of the invention are only examples and should not be construed as limiting the present invention. These and other features, aspects, and advantages of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments.

Referring to the drawings in which like reference character(s) present corresponding part(s) throughout:

FIG. 1 is an exemplary illustration of an exemplary collectable medium in accordance with an embodiment of the present invention;

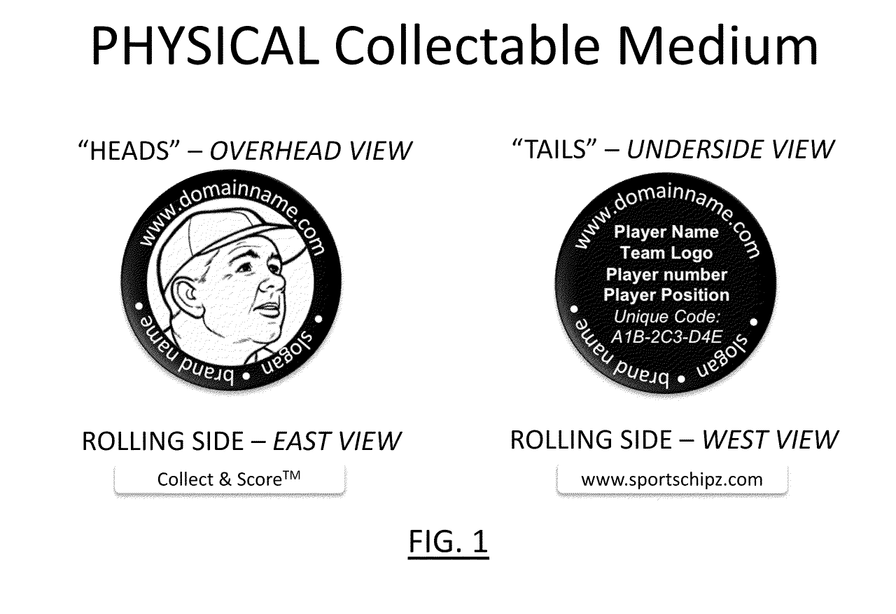

FIG. 2 is an exemplary head overview of the exemplary collectable medium of FIG. 1 in accordance with an embodiment of the present invention;

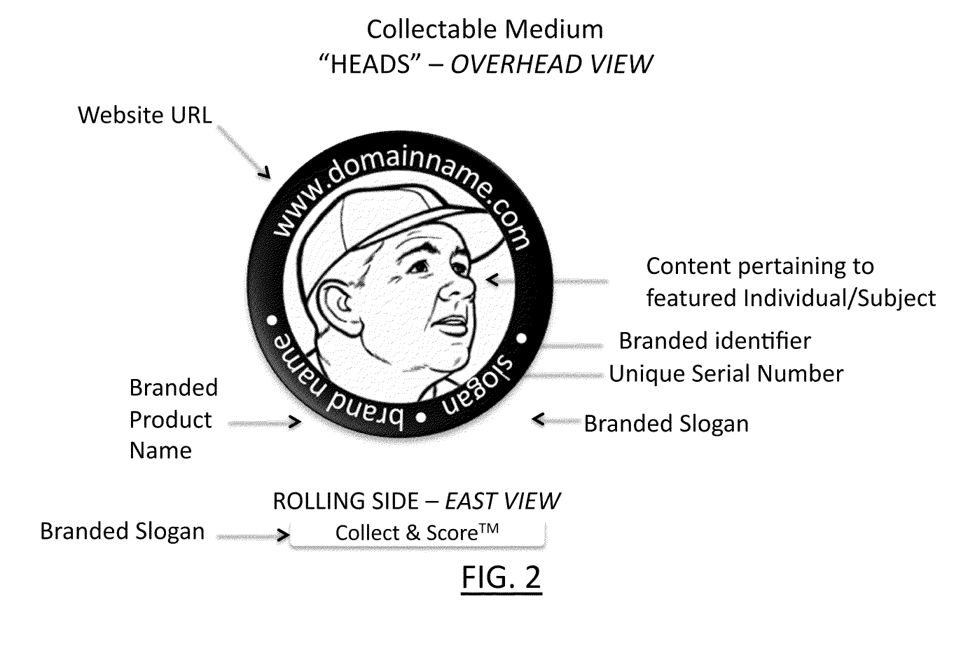

FIG. 3 is an exemplary tail overview of the exemplary collectable medium of FIG. 1 in accordance with an embodiment of the present invention;

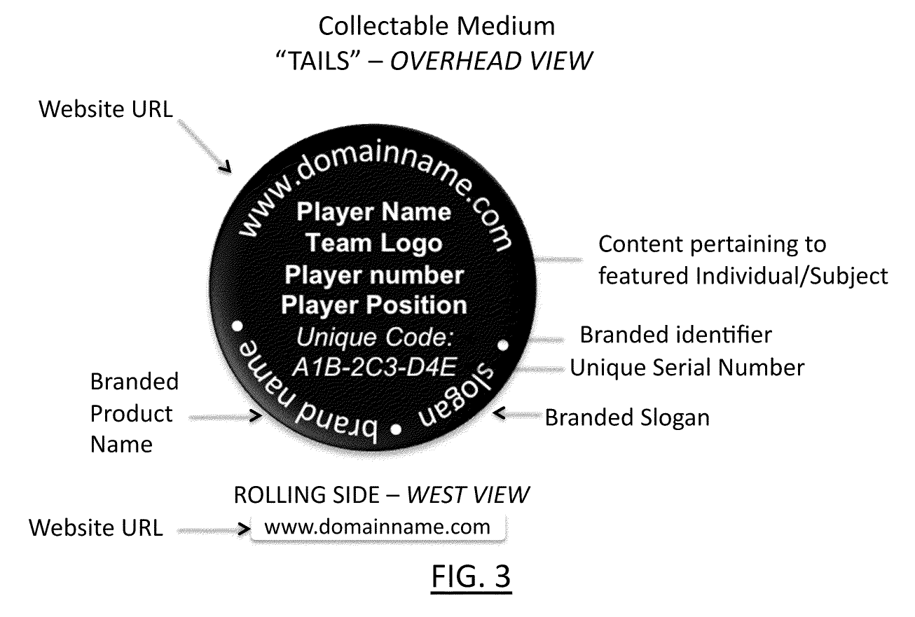

FIG. 4 is an exemplary illustration of a collectable computer networking system in accordance with an embodiment of the present invention;

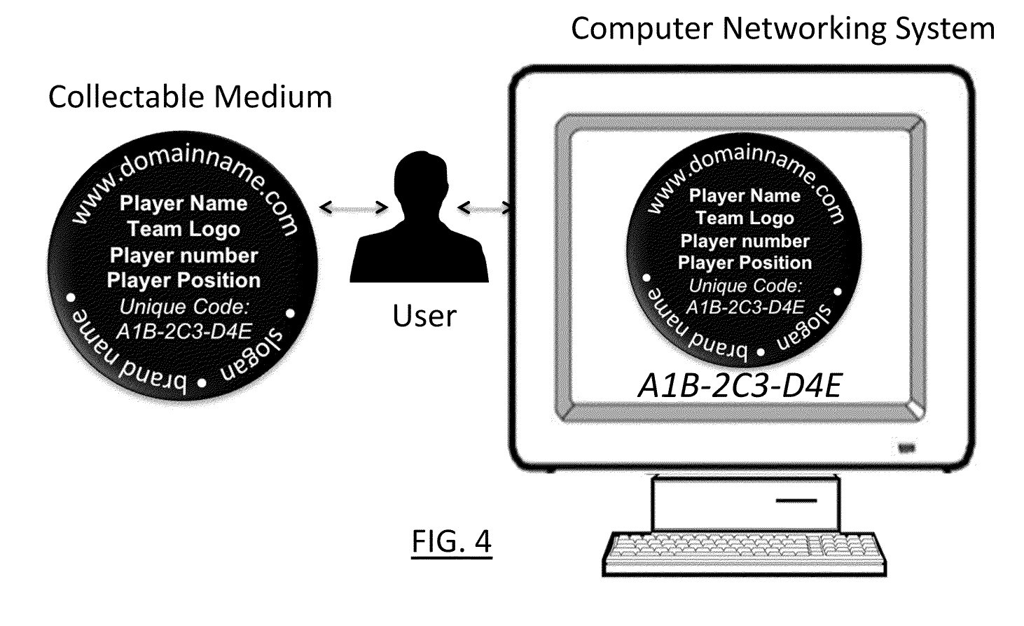

FIG. 5 is an exemplary illustration of both a physical and a virtual collectable medium in accordance with an embodiment of the present invention;

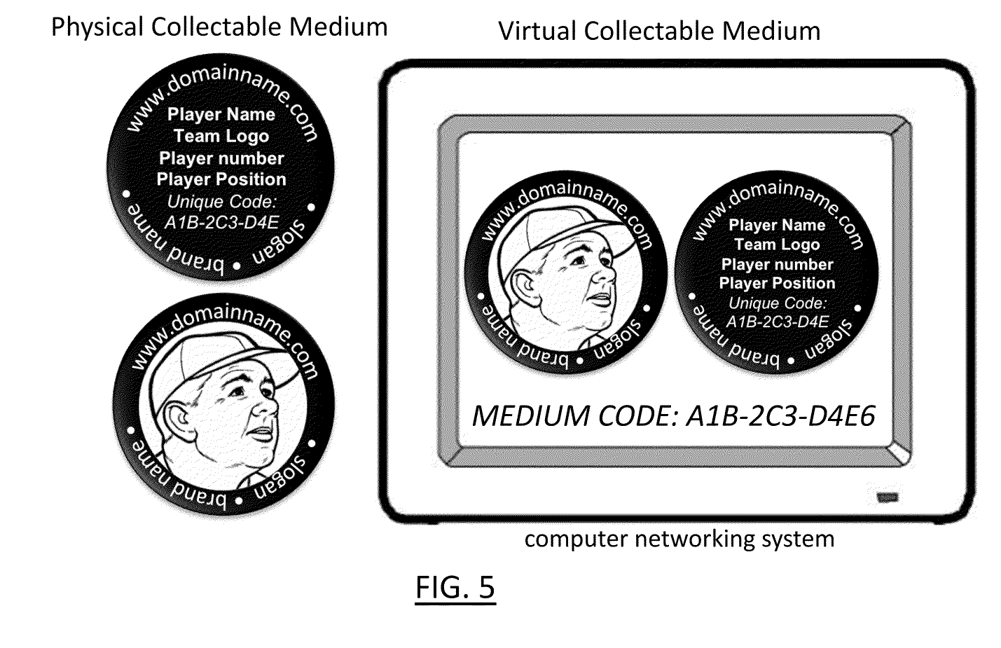

FIG. 6 is an exemplary illustration of a collectable medium, including showing of unique identification system in accordance with an embodiment of the present invention;

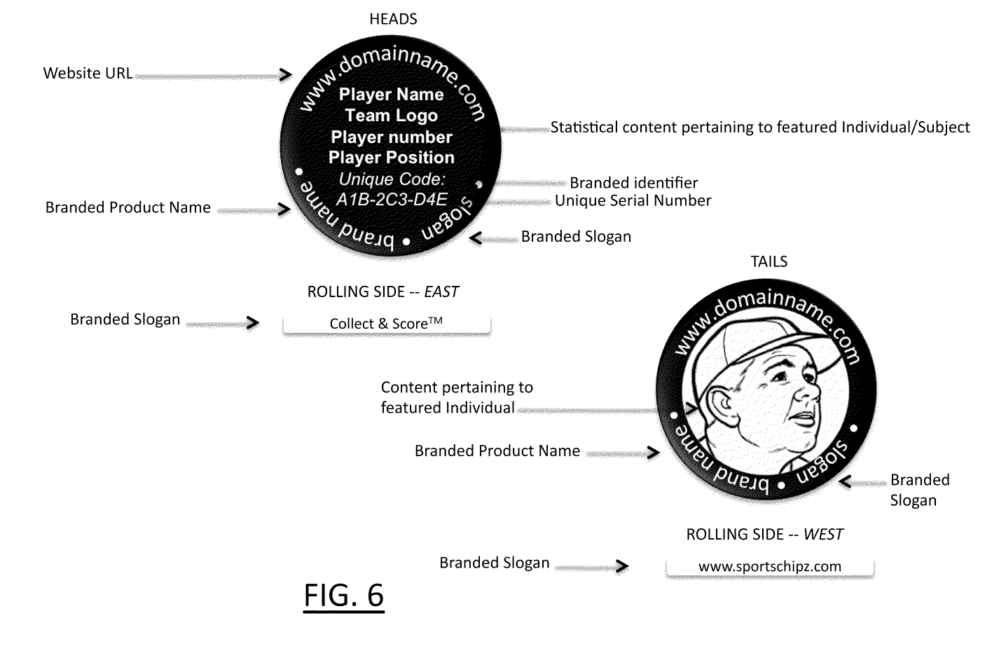

FIG. 7 is an exemplary illustration of a networking system of the collectable computer networking system of FIG. 4 in accordance with an embodiment of the present invention;

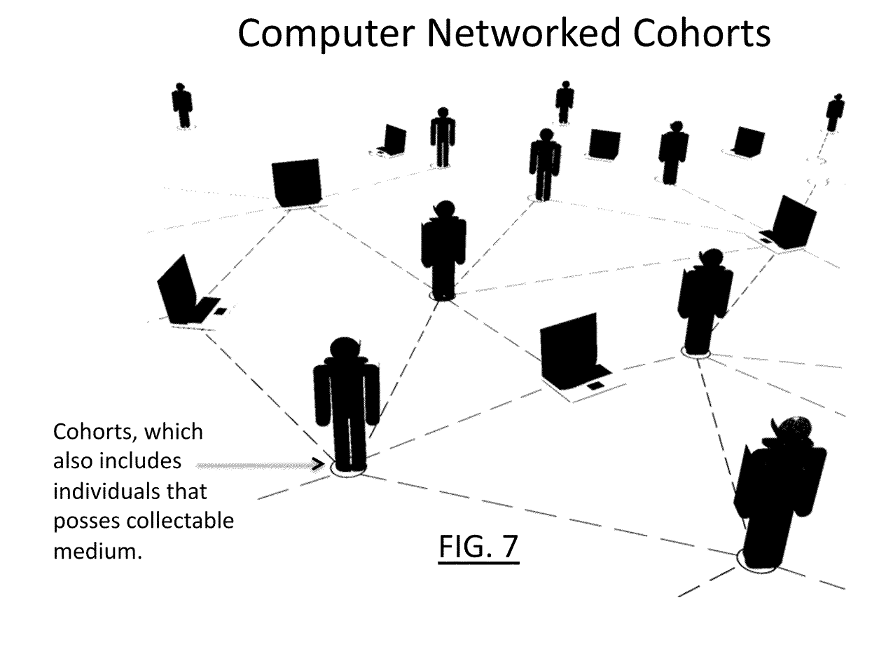

FIG. 8 is an exemplary illustration of association of a collectable medium with a the collectable computer networking system of FIGS. 4 and 7 in accordance with an embodiment of the present invention;

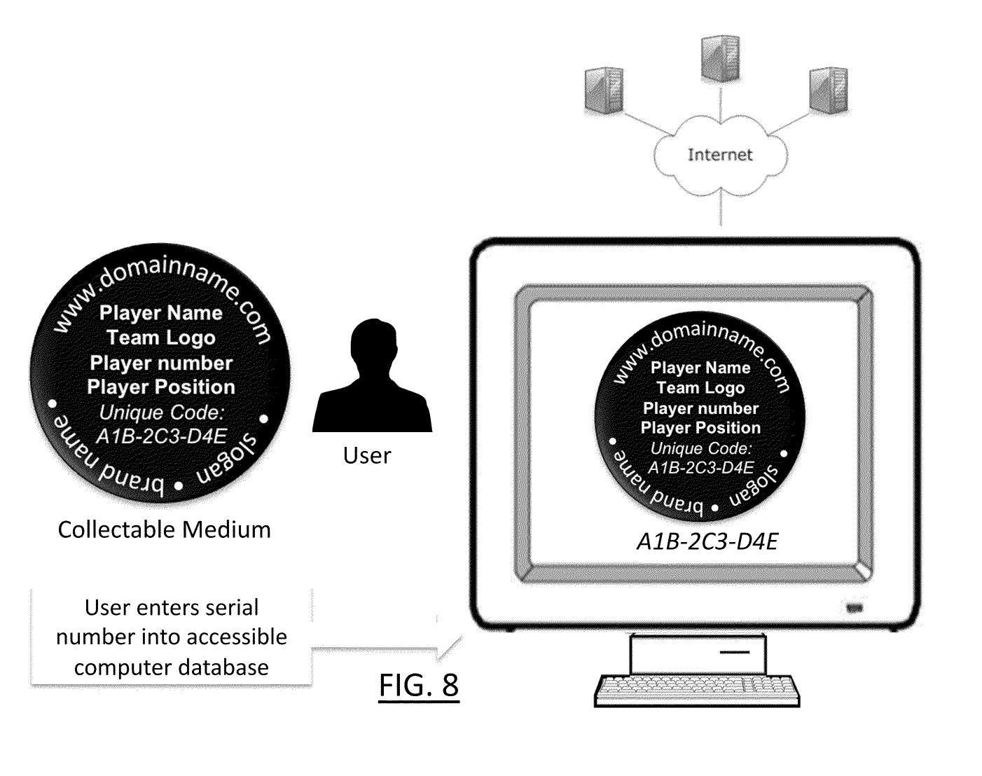

FIG. 9 is an exemplary illustration of an exemplary registration screen of the collectable computer networking system of FIGS. 4 and 7 in accordance with an embodiment of the present invention;

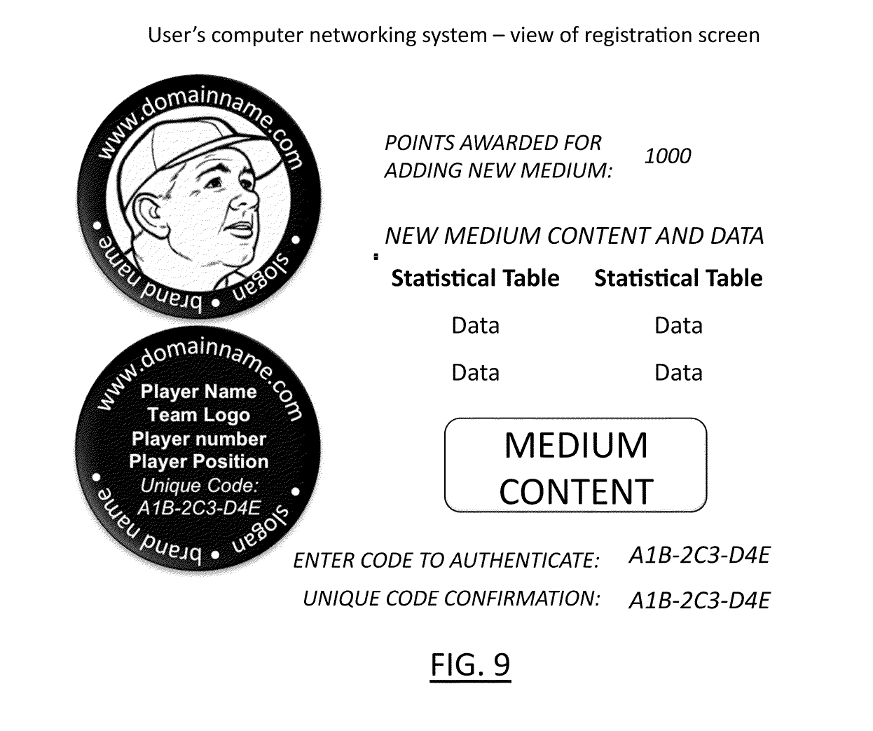

FIG. 10 is an exemplary illustration of an exemplary home page of the collectable computer networking system of FIGS. 4 and 7 in accordance with an embodiment of the present invention;

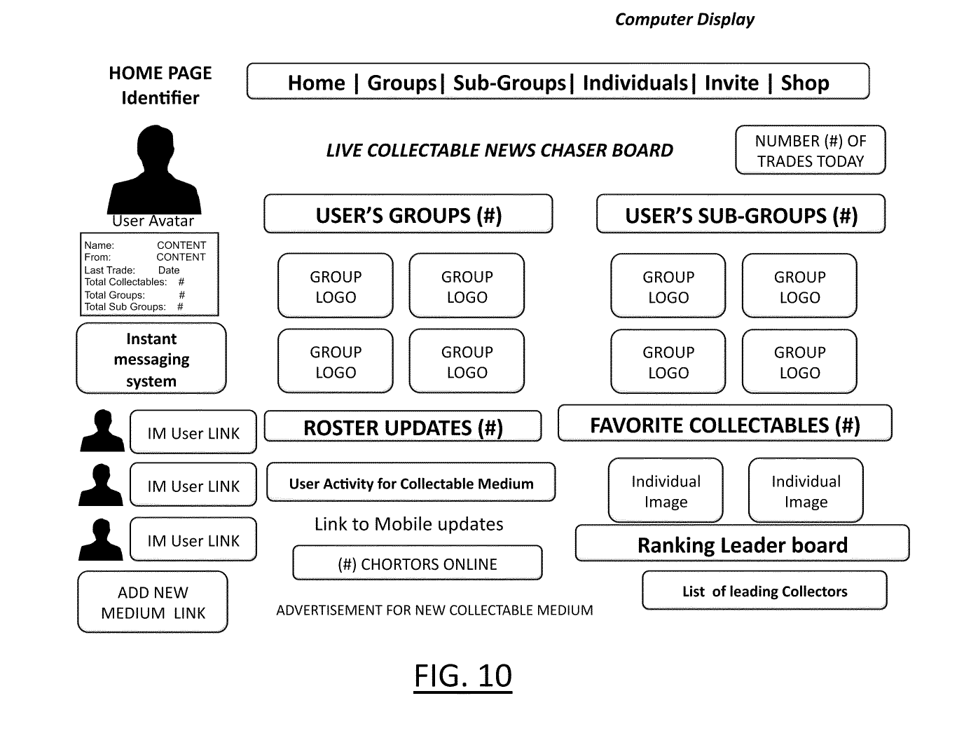

FIG. 11 is an exemplary illustration of an exemplary user profile screen of the collectable computer networking system of FIGS. 4 and 7 in accordance with an embodiment of the present invention;

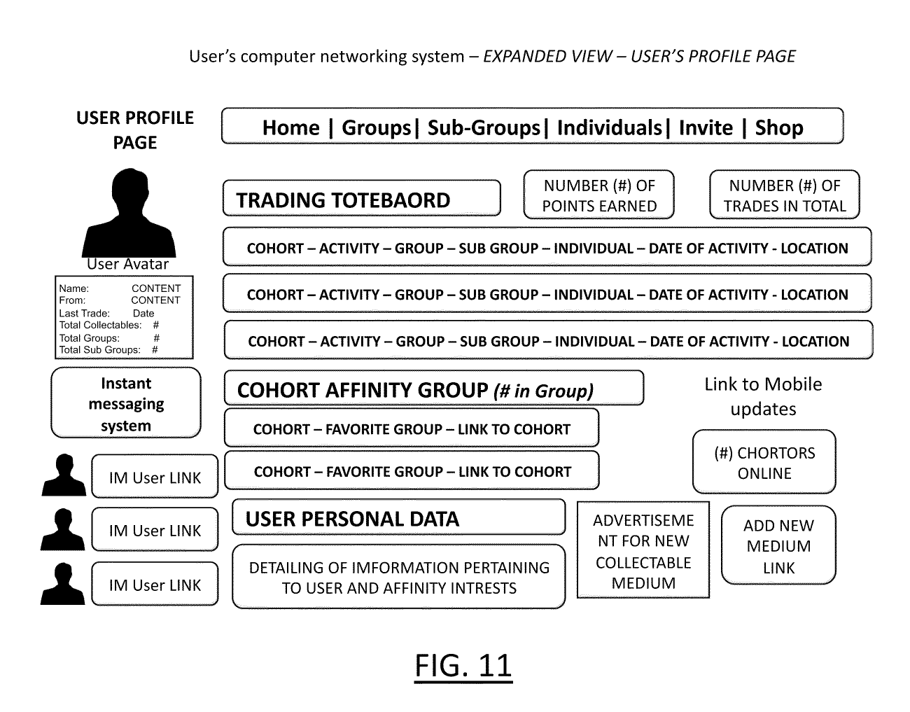

FIG. 12 is an exemplary illustration of an exemplary display of a subset of the collectable mediums of subject of interest of the collectable computer networking system of FIGS. 4 and 7 in accordance with an embodiment of the present invention;

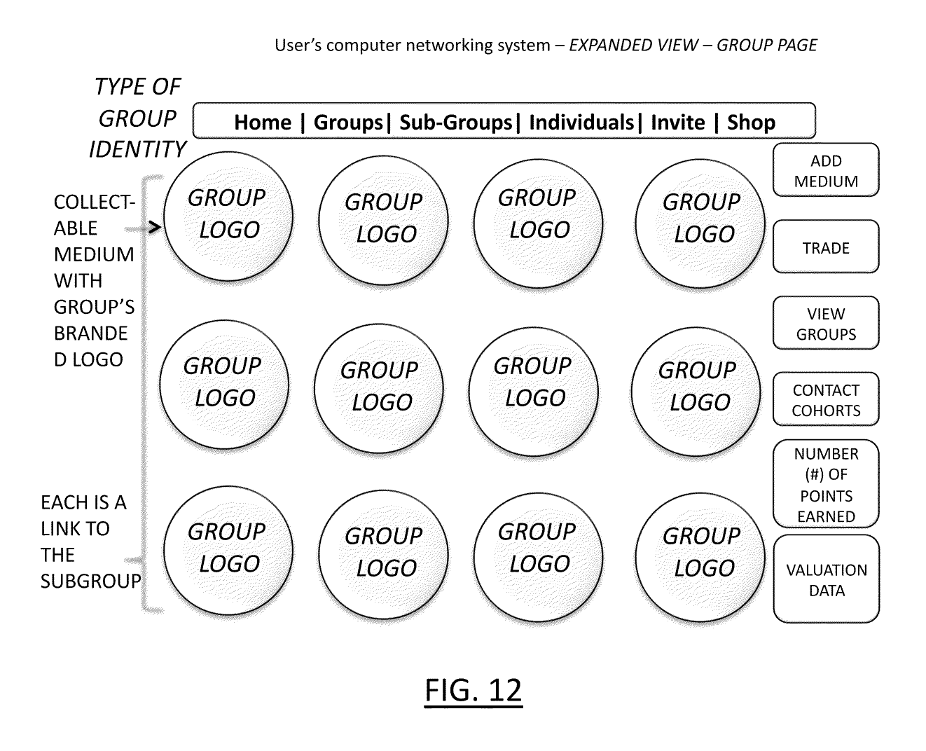

FIG. 13 is an exemplary illustration of an exemplary display of an incomplete subset of the collectable mediums of subject of interest of the collectable computer networking system of FIGS. 4 and 7 in accordance with an embodiment of the present invention;

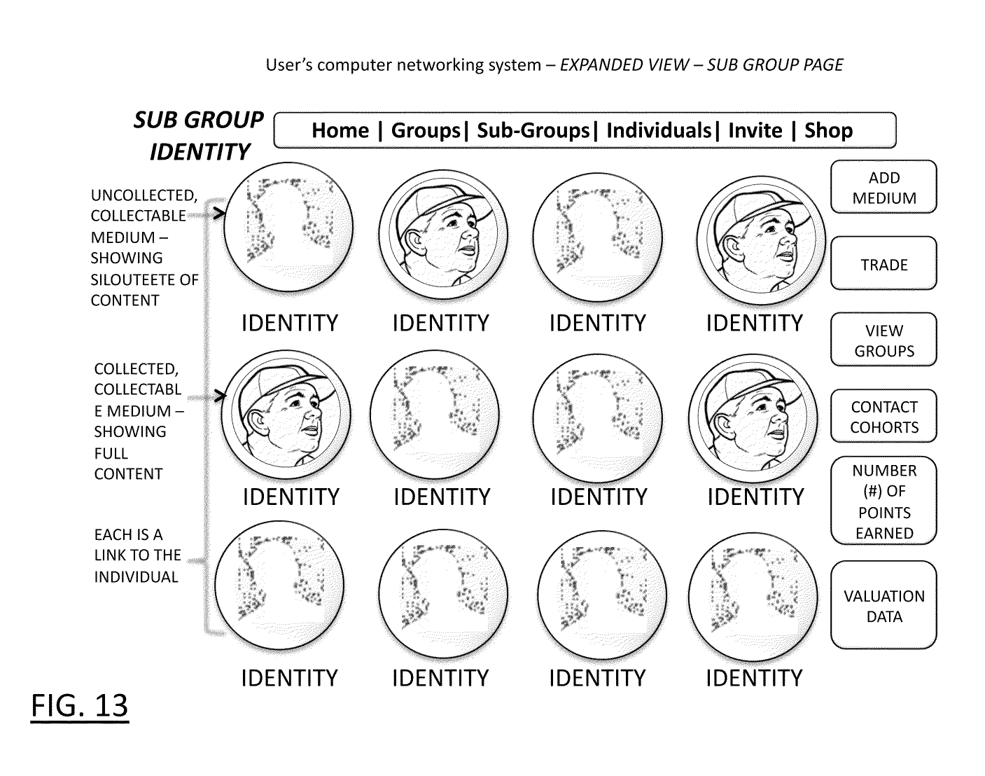

FIG. 14 is an exemplary illustration of an exemplary display of a selected collectable medium from a subset of the collectable mediums of subject of interest of the collectable computer networking system of FIGS. 4 and 7 in accordance with an embodiment of the present invention;

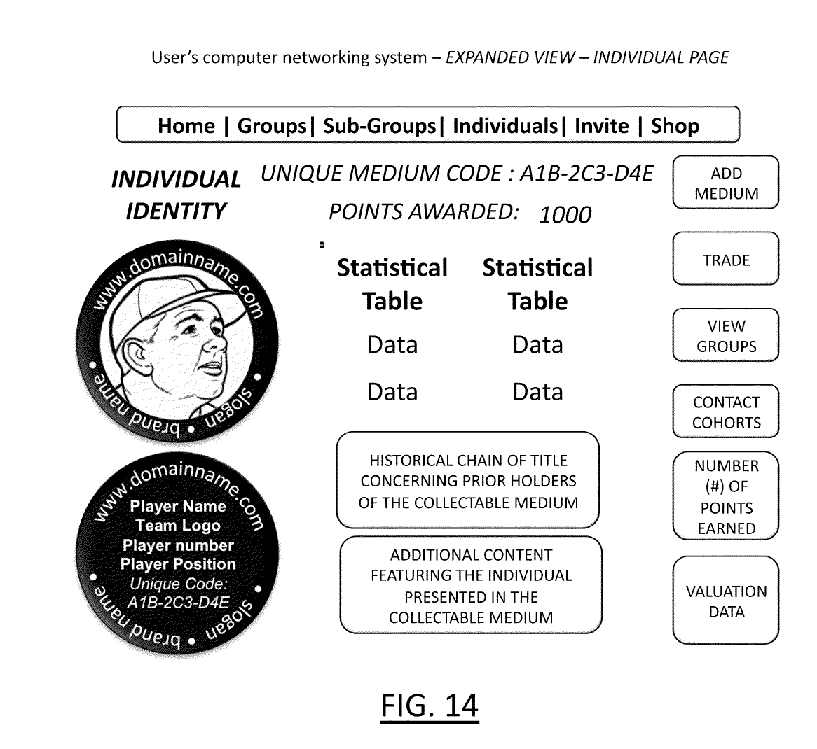

FIG. 15 is an exemplary illustration of an exemplary display of a fully integrating appraisal and trading system of the collectable computer networking system of FIGS. 4 and 7 in accordance with an embodiment of the present invention;

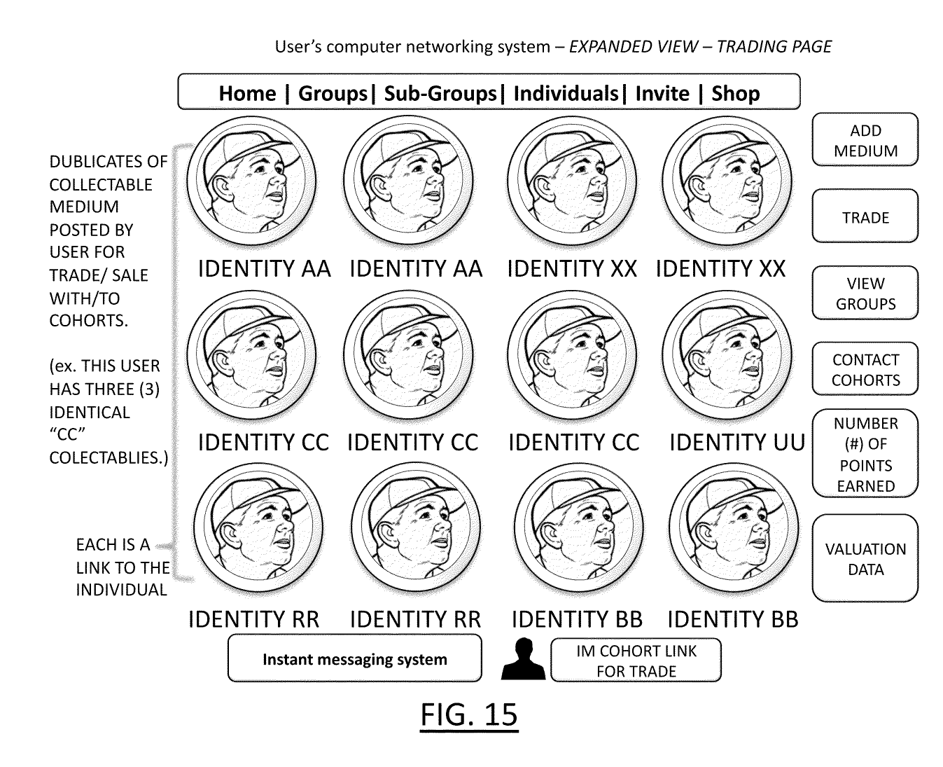

FIG. 16 is an exemplary illustration of an exemplary virtual collectable as an amusement disrupter of the collectable computer networking system of FIGS. 4 and 7 in accordance with an embodiment of the present invention;

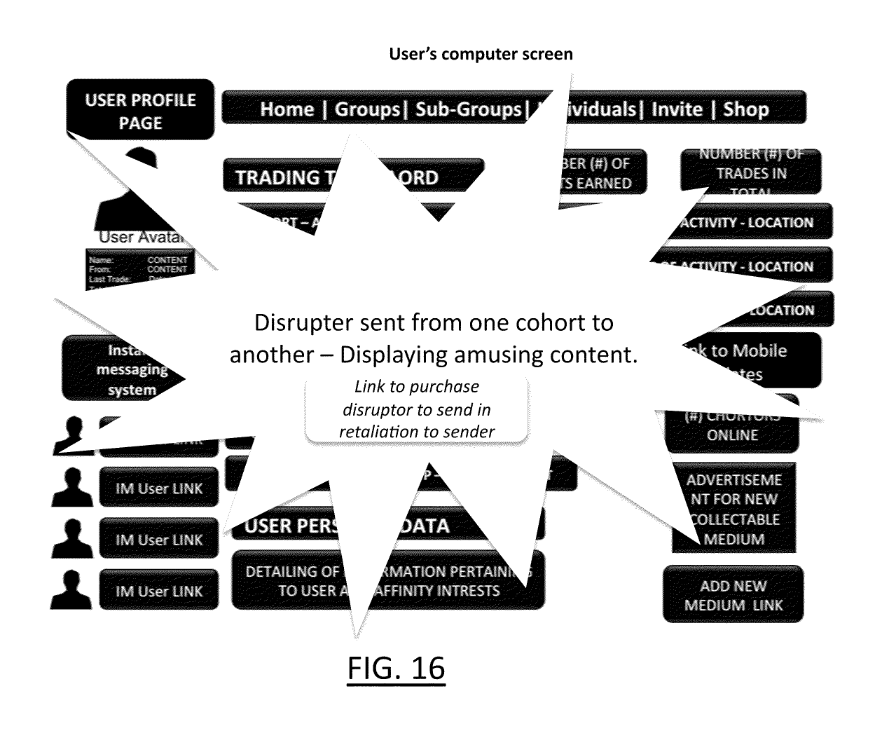

FIG. 17 is an exemplary illustration of an exemplary display of a virtual collectable medium of the collectable computer networking system of FIGS. 4 and 7, resembling a physical collectable medium in accordance with an embodiment of the present invention;

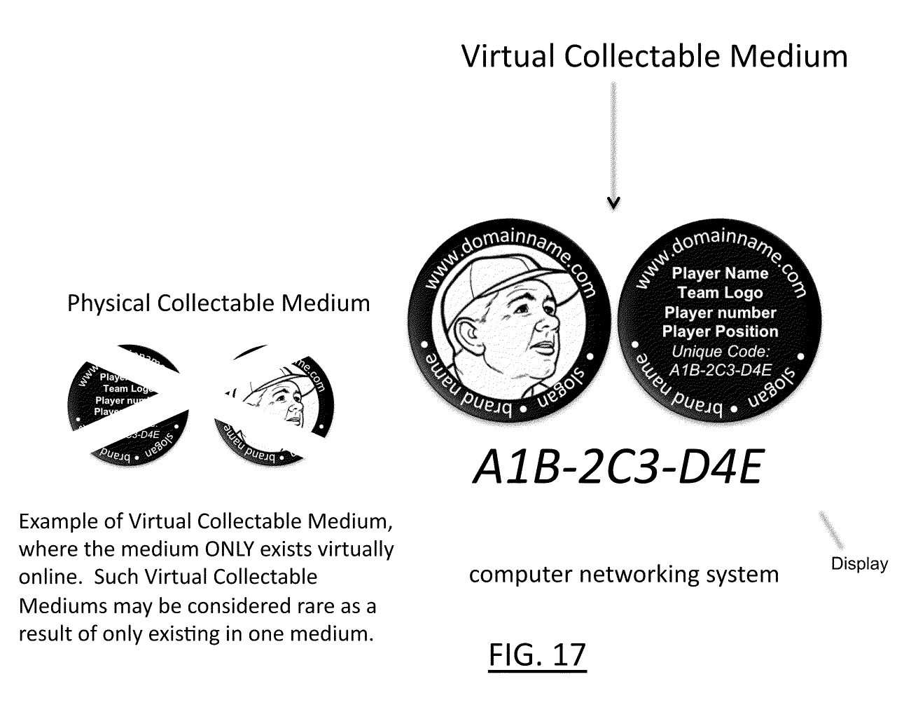

FIG. 18 is an exemplary illustration of an exemplary sponsor provided collectable medium registered with the collectable computer networking system of FIGS. 4 and 7 in accordance with an embodiment of the present invention;

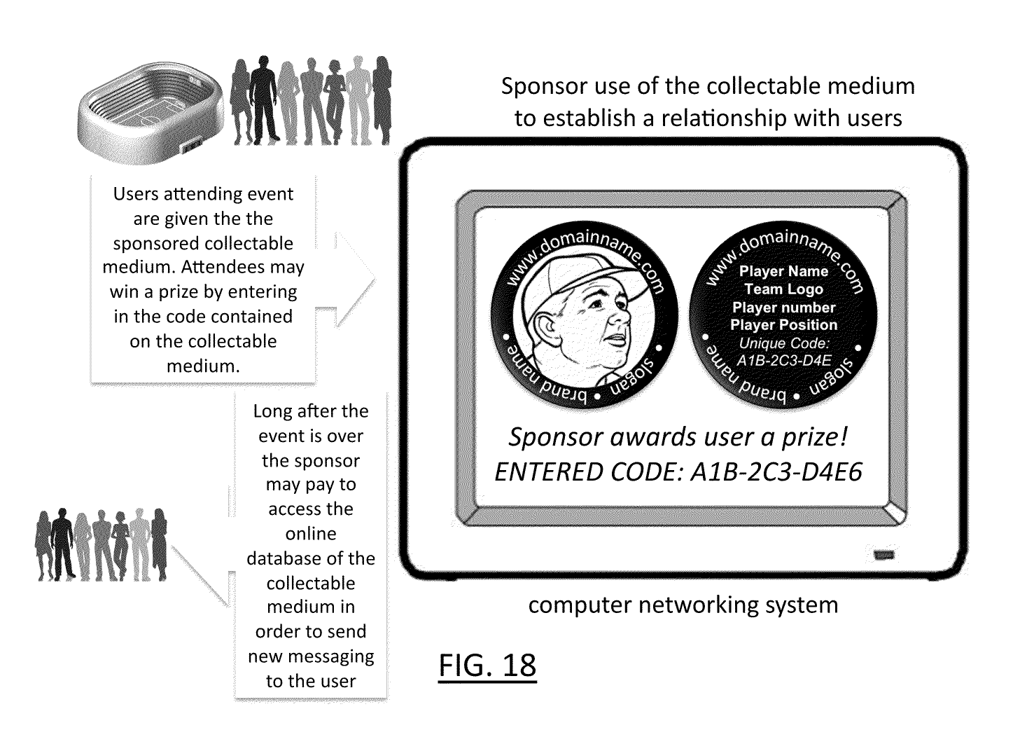

FIG. 19 is an exemplary illustration of an exemplary distribution of collectable medium by sponsors in accordance with an embodiment of the present invention;

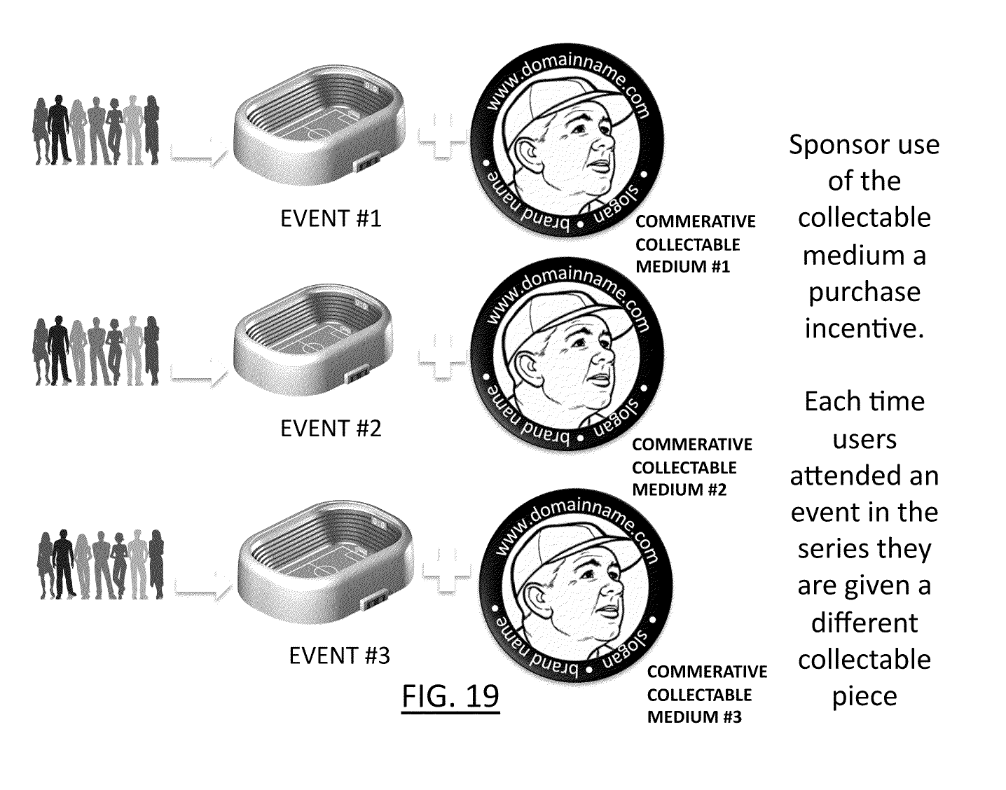

FIG. 20 is an exemplary illustration of an exemplary distribution of collectable medium by a consumer that purchases the collectable medium from a retailer in accordance with an embodiment of the present invention; and

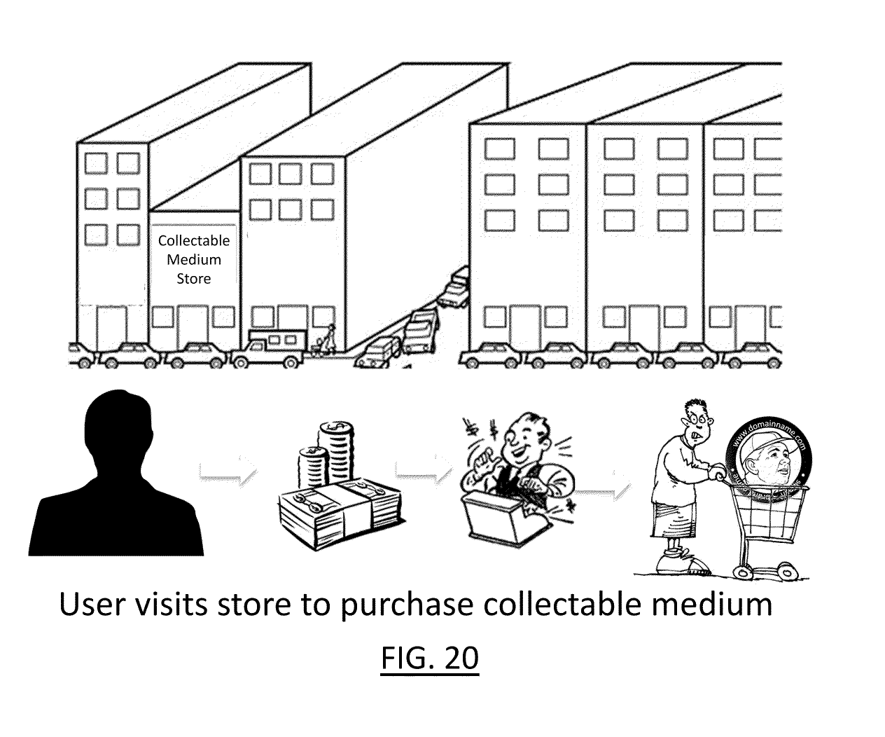

FIG. 21 is an exemplary illustration of an exemplary gaming system within the collectable computer networking system of FIGS. 4 and 7 in accordance with an embodiment of the present invention.

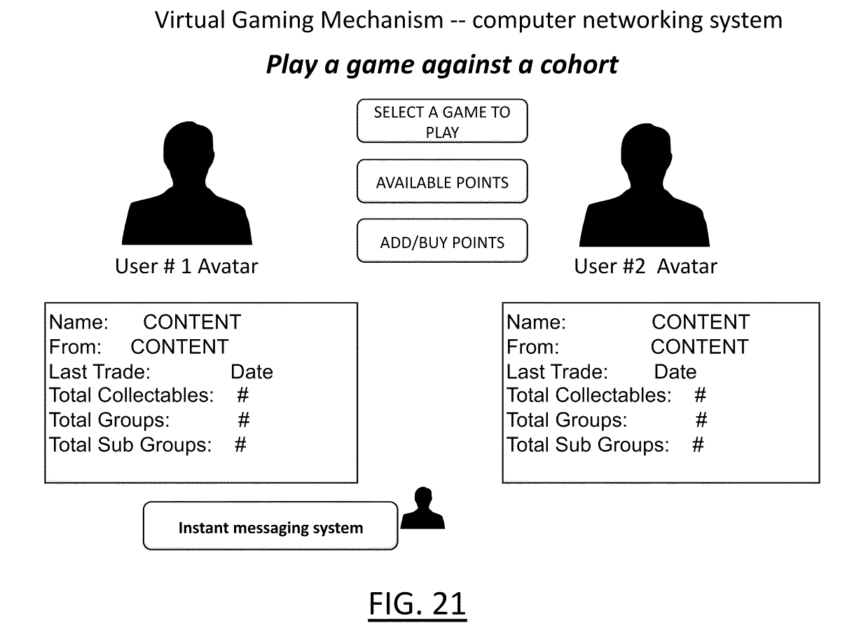

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

For purposes of illustration, programs and other executable program components are illustrated herein as discrete blocks, although it is recognized that such programs and components may reside at various times in different storage components, and are executed by the data processor(s) of the computers. Further, each block within a flowchart (if a flowchart is used) may represent both method function(s), operation(s), or act(s) and one or more elements for performing the method function(s), operation(s), or act(s). In addition, depending upon the implementation, the corresponding one or more elements may be configured in hardware, software, firmware, or combinations thereof.

An entertainment system, method, and computer program for social mapping in combination with a commercially purchased token (or trading card), wherein the system allows a collector to register the token online using a registration code, allowing the user access to various entertainment activities and scenarios in a “social network” via a computer connected to the Internet.

A first member of the plurality of social network members registers the token online using a registration code; the data of which is then sent to an online database. The first member of the network may then access various entertainment activities and scenarios associated with the token's registration code.

The first member may then give the token to a new person, who then registers the token online using the same registration code. The relationship between the first member and the second member is confirmed based on the input codes and maps the first member to the second member. The token can be passed around to new members who would register in a similar fashion, thus extending the network. For younger members (i.e. children) where privacy is a concern, the code associated with the token would become invalid after the initial exchange, thus preventing any third-party users from establishing a relationship with the first and second user.

A means of creating a digitized version of the trading card online, linked by means of a matching serial number on the physical trading card purchased by the collector, which could be accessed by a personal computer connected to the Internet, would allow the purchaser a more varied and interactive means of collecting.

To further increase the satisfaction the owner feels for the product, the trading card would be replaced with a silver dollar-sized token bearing the player's likeness on the “Head” side, and their name, team, player number position and linkable online serial number on the “Tail” side. This (“token”) would also be a more durable ^{and} collectable piece. The addition of an inserted metal puck would make the token heavier and the added weight would give at a perceived sense of value. More specifically, this application relates to an Entertainment System including a website, in combination with a commercially purchased token, wherein the system allows a collector to register the token online using a registration code.

Additionally collectors would be able to interact with other collectors of like interests within the online collecting platform to exchange, sell and/or trade the tokens. Other activities would include social networking, blogging, messaging, social gaming, etc. The collector could also have the ability to have their entire collection of physical trading tokens digitally/virtually displayed on their own personal web pages within the online collecting network. Up to the minute statistics, photo galleries, video gameplay, and other trivia could also be made available to online collectors.

Additionally the method of exchange for children's trading cards, tokens or collectable items could create an entertainment system, method, and computer program for social mapping (“social networking”) in combination with a commercially purchased token, wherein the system allows a collector to register the token online using a registration code, allowing the user access to various entertainment activities and scenarios in a “social network” via a computer connected to the Internet.

Most (open) social networks are designed for mature individuals—usually over the age of 16. On an open social network, there is no way to know for sure if users are who they say they are. As an example, a user who states in their profile that they are a ten-year girl who collects stuffed animals could in fact be a thirty one-year old convicted sex offender. However, in spite of the apparent dangers, more and more underage children are ducking the registration age gates and signing themselves on to adult sites such as Myspaces and Facebooks of the world.

Concerned about the uncertainty of relationships made solely in the virtual world, the average child avoids social networks completely. Most want to communicate freely with their friends, but aren't comfortable with navigating an open social network. However if there were a more secure way to connect online, they may be willing to use such a service. Their parents would also embrace the added privacy and be willing to pay a premium for the service.

The entertainment system, method, and computer program for social mapping described above could be used to create a secure social network for children. To achieve this, children would purchase special silver dollar-sized “friendship tokens” that featured collectable designs or images.

Users of the Entertainment System would go online via a computer hooked up to the Internet to their personal online account and register each token by entering the unique code on the tail side of the token into the website's online code reader. Once the code was verified by the online database, a virtual facsimile of the token would appear on a special page where other virtual tokens were displayed.

Once the initial registration was completed the first user, aka the “Giver,” would hand the token out to a friend or to someone they wanted to become friends with, aka the “Receiver.” The Receiver would go online and enter in the same unique code from the tail side of the token. The online database would confirm the matching codes and the Giver and Receiver would be linked. Once a particular token was registered by both the Giver and Receiver, it would not be able to be exchanged again. The code would become invalid—ensuring that if the token fell into unwanted hands, a stranger could not link to the pervious holder.

Such an online website would have all the features of a real social network—but with one significant difference: children would only be able to communicate with others they physically exchanged tokens with. There would also be no “search” function, so no one could arbitrarily contact the users (children) of the site. This closed social network would be propagated through the exchange of the friendship tokens.

This entertainment system, method, and computer program would provide children with a safer Internet experience and also enable them to communicate more freely using today's technology platforms. An example of such a system, method and computer program for token collecting and social mapping is detailed in the figures.

Provided is an Entertainment System including an offline and online “social collecting and exchanging network” where the user of a token would register the token online (via the Internet) using a unique registration number provided with the token at purchase. This method would be utilized to create a secure online social network specifically for children, that would be propagated though the exchange of “friendship tokens.” This “closed network” would be limited to users whose tokens' registration codes matched each others' in the online database. Similarly this method would be utilized to create an online “open network” used by collectors (of all ages) of special tokens with registration codes that would be linked to a computer database, to exhibit their collections virtually (online) and to socialize with other collectors who shared similar interests.

The Entertainment System to create a secure online social network for children would be powered by a social network engine that would operate as a closed or “internal social network” (ISN). An ISN is a closed/private community that consists of a group of people within a company, association, society, education provider and organization or even an “invite only” group created by a user in an ISN—in this case the network would be propagated through the exchange of linkable online friendship tokens (presumably by children).

The Entertainment System to create an online social network for collectors (of all ages) of special tokens with registration codes that are linked to a computer database, to exhibit their collections virtually and to socialize with other collectors who share similar interests would be powered by a social network engine that would operate as an open or “external social network” (ESN). An ESN is open/public and available to all web users. Unlike other ESN's, this network for collectors (of all ages) of special tokens would be a specialized community that would be focused on trading the theme represented by the tokens, i.e. sports.

Detailed Description—Internal Social Collecting Network Geared for Child Users

A specialized entertainment system would support an internal social network geared towards children collecting tokens that could be redeemed online. Users of such a system would be able to upload personal pictures, create user profiles and link to other users they exchange the friendship tokens with. The social network would also have privacy controls that allow the user and their parent or guardian to choose who could view their profile or contact them, etc.

The method used would be for the intended user: children, to purchase special silver dollar-sized “friendship tokens” (with collectable designs or images). The tokens would be made from Polypropylene plastic, clay filler, with a color pigment processing additive. The material would be injection-molded around an iron disk (aka metal puck)—the disk giving the token weight. Unique alpha-numeric serial numbers would be stamped or printed, or laminated, or silkscreened, or lasered onto the “tail” side (back) of each token. A minimum of nine alpha/numeric letters and numbers would compromise each individual code.

The code could also be displayed as a “Bar Code,” an optical machine-readable representation of the data. Another way in which the code would be accessed is via a passive Radio-frequency identification (RFID) chip implanted within the token. (An RFID is a computer chip capable of creating a signal transmission that can be tracked using radio waves. Passive RFID tags, which have no battery, require an external source to provoke signal transmission.) These two methods would require the user to have a Bar Code or RFID read connected to their computer. The use of such technology would eliminate the need for users to manually input codes and make for a more desirable user experience. The sale of such devices would generate additional revenue for the business venture.

The website Uniform Resource Locator (URL) address would be printed on the “rolling” and tail side of the token. The “head” side of the token would feature emoticons (i.e. typed smiley faces) to help children identify their own emotions to share with friends. (Additionally the emoticons featured on the tokens would be turned into characters by adding arms and legs—they would be exploited as intellectual properties in all forms of media as a way of further extending the brand.)

Users of the Entertainment System would go online via a computer hooked up to the Internet to their personal online account and register each token by entering the unique code on the tail side of the token into the website's online code reader. Once the code was verified by the online database, a virtual facsimile of the token would appear on a special page where other virtual tokens were displayed.

Once the initial registration was completed the first user, aka the “Giver,” would hand the token out to a friend or to someone they wanted to become friends with, aka the “Receiver.” The Receiver would go online and enter in the same unique code from the tail side of the token. The online database would confirm the matching codes and the Giver and Receiver would be linked. Once a particular token was registered by both the Giver and Receiver, it would not be able to be exchanged again. The code would become invalid—ensuring that if the token fell into unwanted hands, a stranger could not link to the pervious holder.

Additionally each token would be worth a certain amount of points. Givers of the tokens would earn points when they first registered a token and then again when the token was registered by the Receiver. In order to incentivize the Receiver to register the gifted token, they too would be awarded points. The more connections made, the more points the users would earn. There would also be ways to earn even more points on the website by doing certain activities (such as logging on, posting photos, and creating editorial content) that would enable users to acquire virtual tokens—special tokens that would only exist online.

After the user was registered they would be able to create their own unique homepage where they could send messages back and forth between with friends they exchanged tokens with, post pictures, build favorites lists and experience other entertainment. The site would also feature an online store where users could purchase additional tokens and themed accessories.

The overall design and features of the Entertainment System would need to be user friendly. The user base would undoubtedly be first-time social network users, so all controls and applications would be accommodating and intuitive. Conversely, the User Interface (UI) would not be overly simple and condescending of the user base. The design pallet would be colorful and appealing to children.

This online website Entertainment System would have all the features of a real social network—but with one significant difference: the users would only be able to communicate with others they have physically exchanged tokens with. There would also be no “search” function, so one could arbitrarily contact the users. This entertainment system, method, and computer program would provide the intended user: children with a safer Internet experience and also enable them to communicate more freely using today's technology platforms.

Before the intended child user would be given access to the website, a parent or guardian would be required to register the child online. The registration system would obtain verifiable consent from a parent or guardian, enabling the web service to comply with the Children's Online Privacy Protection Act of 1998, “COPPA.” A one-time validation would consist of a nominal charge to the parent or guardian's credit card. Thereafter that there would be no monthly fees. During registration, parents or guardians would also be permitted to add other children from their immediate family, (or later via the Mange Accounts module).

Such an online website Entertainment System would offer the following safety and privacy features:
Parental consent would be verified before users were allowed access to the site.
Site users would only be able to communicate with others they physically exchanged token with.
The unique token codes would become invalid after the second user registered the token, thus ensuring that if a token fell into unwanted hands, a stranger couldn't link to the pervious token holder.
The web platform would be designed to prevent user's postings (writings and images) from being picked up by search engines.
All communications on site would be filtered for improper language (swear words) and inappropriate emoticons.
There would be no Search controls, so no one could arbitrarily contact site users.
When visiting a friend's profile, users would only be able to view the “friend's friends,” that they exchanged tokens with.
Users would be permitted to post only a limited amount of information on their profile pages.
“Notify Site Monitor” buttons would encourage users (presumably children) to alert the website administrator/site monitor if they came across inappropriate content.
When responding to issues concerning a child's account, i.e. the posting of inappropriate content, the site monitor would send alert messages to both the offending user and their parent.
Parental Controls would enable adults to toggle on or off age-appropriate features. The control would also enable the user's account to be temporarily deactivated or deleted. Deleting an account would purge all the all data and images that a user uploaded to their profile—permanently removing them from the website.
A section on Internet Safety, written with a youthful slant, would address common concerns and provide usage tips and helpful links for children.
A section on Internet Safety, written specifically for parents, guardians and educators, would address many common concerns and provide usage tips and helpful links for adults supervising children who used the web service.
Additionally promotional tokens would be made available to users of the system. These tokens would be custom made with a sponsor's logo or artwork on them. Sponsors would then give the tokens away as special promotions—i.e. “Buy a Kids Meal at SuperDuper Restaurant and get a free Collectable Online Token!”
The promotional tokens would have a code that was preregistered to a special web page created especially for the sponsor. Users would register these promotional tokens to their profile. In the process they would be awarded a certain number of points to spend on the sponsor's special microsite. (Also known as a minisite or weblet, the microsite is an Internet web design term referring to an individual web page or cluster of pages which are meant to function as an auxiliary supplement to a primary website.)
These microsites would reside within the main online domain and could only be accessed by registered users who have accepted and registered a sponsor's token.

Each promotional “microsite” would be unique and contain applications such as virtual goods, games, downloads and sweepstakes. The sponsor would advertise their products on the microsite, and be able to send certain messaging to users that registered their promotional tokens. This virtual “connection” between the userbase and sponsor would continue well beyond the date the initial token was acquired—thus creating a long term relationship between the advertiser and the consumer.
In keeping with government regulations pertaining to advertising directed at children, the promotional tokens linked to a minor's profile would only permit the child to view the sponsor's site; but not permit the sponsors to view the child's profile nor be able to communicate directly with children who used the microsite.
Additionally these promotional tokens would be offered as “in-store,” promotions (handed out during “check out” to customers purchasing of a sponsor's product), “on-pack” promotions (directly attached to a product), and “in-box” promotions (i.e. inside a cereal box). These promotional token sponsorship programs would provide the operator of the web service with additional revenue.
Additionally special tokens for non-profit organizations and religious groups would be produced. These tokens would be custom made with the group's logo or artwork on them. Organizations would use these tokens for awarding accomplishments. Such a bestowment would go beyond the traditional medallion or certificate and would deliver a tactile AND virtual connection. That connection would be constantly managed through continuous communications from a specially branded microsite programmed by the organization.
Some of the features of the current embodiment include the option to offer various accessories, and/or services to the user. Examples of these accessories would be digital code readers, published collector's guidebooks, token collection display units, tokens carrying cases, branded apparel, as well as branded food products. These accessories would provide the user of the service with a value-added experience and the operator of the web service with additional revenue.
Below is an outline of the basic entertainment system (described above), which would support an internal social network propagated through the exchange of collectable friendship tokens by children:

1. The following entertainment systems would be included in the website:
a. A Registration module would “sign up” users to the site. It would be divided into Child & Adult Registration
   i. Child Registration would require children to create a username and password. It would also ask for the child's birthday to confirm that the child was within the approved age bracket for site users (age 7 to 17).
   ii. After successful completion of Child Registration, Adult Registration would require the child's parent or guardian to also create a username and password. The system would also ask for the parent or guardian's age. It would prompt them to input a birthday to confirm they were over 21. They would need to check a box signifying that they had read the “term and conditions” regarding use of the site. The system would also require the adult to make a nominal credit card charge via an online payment gateway. This charge would verify that a credit card issued to an adult was used as a form of verifiable consent. Such a transaction would confirm that an adult gave permission to a child under their supervision to visit an online website that collects personal data from users under 13 years of age.
b. Profile fields would specify the user's name, date of birth, school, and certain personal preferences
   i. Avatar photo uploading would enable a user to post a profile picture.
   ii. Avatar photo editing would enable users to crop, rotate and edit their photo(s).
c. A Token Database Administration would feature:
   i. A Database Management System would allow the administrator to manage (create/edit/delete/retire) a list of tokens including name, point value, image, and particular information about the token such as: color scheme, release date, biographical data and trivia. These including the associated list of friend codes would be uploaded as Comma separated values “CSV;” (A CSV file is used for the digital storage of data structured in a table of lists form, where each associated item (member) in a group is in association with others also separated by the commas of its set.). Friend codes would include a list of unique codes that are available for a purchaser to enter as part of friending process).
   ii. The Friend Code Management system would need to support a large number of token codes in the tens of millions. Such number generation and management software would need to be capable of generating millions of numbers and keep track of them, so they would not repeat. Additionally the software would also need to cross-reference token colors, designs and other pertinent information. The database administrator would need to be able to be export this data as CSV/Excel files that would be given manufacturers producing the tokens.
d. A Token Friending System would feature:
   i. Token Registration: token purchaser registration of code for items purchased
   ii. Token Linking: token gift recipient entering code and either signing up as a new user or adding new token to their gift list
   iii. Adding linked users to each other's friend/contact list
   iv. A friend “feed,” a data format used for providing users with frequently updated content, would list when a token is confirmed to have been gifted from one user to another
e. A Tokens Given and Confirmed module would list tokens given including the identity of individuals the user gave the token to (aka the Receiver). This would be linked to from the user's personal homepage.
f. A Tokens Given but Not Confirmed module would list tokens given but not yet confirmed by a Receiver. This would be linked to from the user's personal homepage.
g. A Tokens Received module would show a list of total tokens received along with image and number of each type received, and people who gave them (aka the Giver). This would be linked to from the user's personal homepage.
h. A Tokens List module would display a public list of tokens a user has received. This would be linked to from the user's personal homepage.
i. A Set Mood module would be created that would select from the list of all emoticons in the online database to represent the Current Mood. The module would display an image as well as text name of the emoticon selected. This would be linked to from the user's personal homepage.
j. A Tokens Gallery module would show all tokens in the system created by administrator (minus “retired” tokens), placed on a standalone page, which could be browsed. Each token's name, image and individual data would be listed.
k. Token usage analytics would include:
   i. Number of tokens registered
   ii. Number of tokens outstanding
   iii. Regions, stores where tokens were purchased
   iv. Sex of token purchaser
   v. Age of token purchaser—ranges, averages

2. The following entertainment systems would also be included in the website:
a. An Inbox for private messages
b. Privacy settings and parental privacy controls would enable parent/guardian administrators to set the fields in each child's profile to “Public” or “Private”. In addition the parent or guardian would be able to temporarily deactivate or totally delete a child's account.
c. A Photo gallery would include tags, comments, and privacy alert controls
d. A Notes application blogging functionality would include the ability to publish an internal blog
e. A Groups application would enable the aggregation of users.
f. An Events application would help users keep track of calendared events such as birthdays.
g. A Media Posting Gallery application would enable the posting and viewing of videos and audio files.
h. A Feed would update users on their friends' activities, i.e. tokens added, profile pictures changed, and virtual gifts received.
i. A Messaging System would utilize these two features:
   i. A profile commenting system, which does not include comment moderation by the user being commented on
   ii. A profile testimonial module, which would include comment moderation by the user being commented on
j. Mobile: a Short Message System (SMS) and mobile version would be also be deployed
k. Networks would be created around region, or school that allow select users to join
l. A Create Your Own Token Module would also be made available for users of the system.
   i. The system would access a live web camera connected to the user's computer to take a photograph of themselves or use an existing image (which could be edited/manipulated in fun ways) and then printed out onto a sheet of round stickers that could be placed into special tokens and given out to friends.
m. A Virtual Goods Module would enable users to buy, gift and display virtual tokens acquired.
   i. The platform would feature a store where users could preview “virtual tokens” and then purchase them using points they had earned from collecting the physical tokens.
   ii. Users would have the option to buy the goods for themselves or send them as a gift to another user.
      1. An online payment gateway would enable site users to purchase additional points (that could only be spent online) to acquire virtual goods. These purchased points would supplement existing points users accrued by collecting and registering physical tokens.
   iii. A virtual Gallery would feature all the virtual goods acquired by a user. (The user could opt to have certain virtual goods publicly or privately viewed)
n. A My Tokens widget would syndicate users' tokens to other websites
o. A token voting system would be created to determine popularity of the tokens
p. The hosting environment for the platform would provide multi-server, load balanced configurations
q. User data and metrics
   i. A server side usage reporting package would provide analytics
r. Homepage Management the system would be designed to include the ability for the network operator to:
   i. Control module placement on left, right margins
   ii. Create an announcements module
   iii. Reskin site through changing theme including background image, site colors, etc.

### 1. Overview

A social networking portal for kids below the age of 13 would be developed. This portal would adhere to COPPA requirements. This document details the requirement for the Webservices as well as the admin tool for the portal.

1.1. Objective of the Proposed System

The proposed system would provide a social networking platform for kids below 13 with features like messaging, buddies, instant messages, token transactions, photo albums.

Registration/Login:

The objective of this module of the portal would be to capture user registration details. IF the user is already a registered member of the site, then it will verify the credentials and allow the user to enter the site. In case of the credentials not matching a valid record, the system will prompt a message on the screen suggesting Invalid user id/password message.

Message Center:

The objective of this module of the portal would be to allow a user to send messages to buddies. The user can select the buddy to send the message to—the message will be sent to the buddy. The options available to the user would be
View Inbox
Compose New Message
Check the Sent Items
Delete mails

Photo Albums:

The objective of this module of the portal would be to allow the user to upload photos and group the photos to create an album. The user can create an album and load photos to be associated with the album. If the user deletes any photo from the album, this photo will get permanently deleted.

Instant Messaging:

The objective of this module of the portal would be to allow the users to send instant messages to other users. This would also act as news feed showcasing any updates from other friends.

User Profile:

The objective of this module of the portal would be to allow users to enter details for various components like status update, secret message, etc. It would also allow users to report various content on the user profile, if the find it to be offensive. The network admin will be responsible to take the necessary action.

Admin Module:

The objective of this module of the portal would be to list out all the functionality provided to an administrator to manage the site. The options available to the administrator are—
Generate new Tokens codes
View all users.
Inactivate/activate a user
Send and receive messages
Delete offensive content
Upload photos of the tokens for the tokens gallery
Option to upload external files as themes.
Reports

1.2. Business Effects

This system would provide a COPPA compliant social networking portal for kids.

### 2. Project Scope

The scope for the current phase of the project includes development of webservices for the following:

1. Registration and Login

2. My Page

3. Message Center

4. Instant messages

5. Photo albums

This scope also involves developing an admin module for managing the site and its content on the guide lines highlighted by the ESRB.

### 1. Registration and Login:

We will provide the business logic and the engine for the website to handle the login and registration process. This will include—
Registration for kids
   User name
   Password
   First Name
   Last Name (not to be accepted from the user for the moment)
   Gender
   Year, Month and Date of birth (Year not to be displayed on profile page)
   School name
   Parent's email address.
   Avatar Picture
Registration for parents
   User name
   Password
   First Name
   Last Name
   Email address
   Credit card type
   Credit card number
   First name on card
   Last name on card
   Card expiration date
   Card verification number
   Credit card billing address
   A $1 charge will be transacted. This is a onetime fee for lifetime membership.

The parent can sign up his/her kids at the point of his/her own registration. A new screen option to enter all the details asked for the child registration will be asked except the parents email address.

The parent will choose what information of the child is viewable on the site. The parameters that the parent can choose from are—
Location
Birthday (with the year)
Email Id
Gender
Full Name Display
Allow Messaging
Allow Uploading Pictures
What am I up to
About me
My Friends
My moods
Secret messages
School

All these parameters, which will be individual check boxes, will by default be allowed/checked for every child. The parent can uncheck the particular option if it's not to be displayed or not allowed.

The parent can register more than 1 child at a time. The parent has to pay 1$ for any number of Kids they want to register on the site.

Note:—The credit card details will not be stored in the database for security concerns. These details will be passed as parameters to the payment gateway directly.

### 2. My Page:

We will provide the business logic and the engine for the website to handle adding, editing process for profile content. This will include—
Avatar picture
User name, Location, Gender, Birthday, School
What am I up to
About me
My Mood
User photos
Friend list
Secret message
My Lists
Instant message
My Tokens
My Stats
Invite friends

### 3. Message Center:

We will provide the business logic and the engine for the website to handle message center module.

The options covered in the message center would be—
Inbox
   User Id of the buddy who has sent the message
   Avatar picture of the buddy
   Chip name of the picture
   Subject of the message
   Date and time—the message was received.
   A ‘X’ option incase the user wants to delete the message
Compose
   Buddy Id to whom the message is to be sent
   Subject of the message
   Message Body
   Two Buttons—“Send” and “Cancel”
   Image of the buddy to whom the photo was sent
Sent
   Buddy Id to whom the message was sent
   Subject of the message. When the user clicks on the subject, the message body would be displayed.
   Date and time the message was sent
   A ‘X’ option incase the user wants to delete the sent message.

### 4. Instant Messages:

We will provide the business logic and the engine for the website to handle Instant messages These messages will be displayed on the users profile page.

### 5. Photo Albums:

We will provide the business logic and the engine for the website to handle the management of photos uploaded by any user. This will also take care of the album management part. This will include—
Photos
   Can upload files in .jpeg, .gif, .png formats only
   The file size should not exceed 2 MB
   The buddies will have an option to mark any of the photos as ‘Offensive’
   Photos can be edited for changing the tag and also rotated
   Photos can be deleted.
Albums
   Can create a new album
   Give an Album name
   Can associate photos with the album created
   Can dis-associate a photo from an album
   Can delete photos from the album.

### 6. Manage Kids Page:

We will provide the User Interface, and the business logic for the website to handle this section. Using this page parents can manage their Kids. They can Add more kids, activate kids, freeze their Kid accounts or delete their kid accounts.

### 7. Point System:

Kids on the site will be awarded points for the actions they perform on the site. Below is the detail of the requirement:

1. Global
a. Each time a user receives points we trigger a visual display of the points added
b. One new static page will be added to show the point values

2. Add Points for each action
a. Parent & Kid Sign Up in one session (Option 1)
b. Parent Completes Sign Up after getting email (Option 2B)
c. Initial Registration of a chip
   i. Giver receives predetermined chip points value (ex. 5000 points)
d. Second Registration of a chip
   i. Giver receives predetermined chip points value again (ex 5000 additional points)
   ii. Receiver receives predetermined chip points value (ex 5000 points)
e. Uploading an Avatar
f. Add an About Me to your profile
g. Invite a Friend
h. Set a secret Message to your friend
i. Customize Profile Page (backgrounds)
j. Create a new “My Lists” category
k. Create a Photo Album
l. Add a Photo to your “My Photos”
m. Collect all 200 tokens in the entire series (win double points). This would also include giving additional points once a user has reached a pre decided slot of # of tokens collected, for E.g. 50, 100, 150, etc.

### 8. Admin Tool:

We will provide the User Interface, and the business logic for the website to handle the administrator module. The access to the administrator module will be a separate URL. The options covered in the message center would be:
Tokens management
   Generate new tokens codes with all information required to be displayed in the token gallery
   Upload photos of the tokens for the gallery
   Add and Delete photos from the token gallery
   Coordination of points.
   Send a message to friends suggesting that user has added a new chip is registered by the user.
   Emoticon glossary—add, update, delete.
Users
   View Users
   Activate/Inactivate users
   Delete Users
   Show users on line
Messaging
   Receive messages from users
   Send messages to users
Offensive content
   View offensive content
   Remove the offensive flag
   Delete offensive content.
File upload for themes
   An option to upload external xml & Zip files for themes
Points to be controlled for widgets and games **
Managing Static content
   Option to view and edit static content will be provided. This include—
      FAQs
      Privacy
      Terms and conditions
      For Parents
      Our Partners
      About our company.
      Where to buy tokens.
      Email templates
Reports
   Which tokens are most popular
   How many tokens were given/received on a day
   How many active users are accessing the site.
   Most active users. (based on how much time the user spends on the site)
   Which user has registered the most tokens
   Which user has the most points.
   Notification emails: List of emails sent to parents for their kids offensive behavior
   Notification messages: List of messages sent to kids for being offensive

### 3. Functional Requirements

3.1. Functionality

Registration and Login:

| | Functional | Description |
|---|---|---|
| Ref# | Requirements | (Requirement Details/Business Rules/validations.) |
| RM-S1 | Allow user to | The user would click a ‘submit’ option on the screen. This will |
| | sign in | call a java web services method which will verify the credentials |
| | | supplied. If the credentials are valid, the user will be |
| | | successfully logged on to the system. If not an appropriate |
| | | message will be displayed on the screen suggesting the error. |
| RM-S2 | New User - | Accept the credentials. Check if the user name is a unique one |
| | Sign Up | and valid (without special characters or any abusive terms). |
| | | Once the user clicks on the ‘Submit’ option, the UI will invoke a |
| | | java method call and after all the validations, the credentials will |
| | | be stored in the database. An email will go out to the user |
| | | suggesting successful sign up. |
| RM-S3 | Parents - Sign | Accept the credentials. Check if the username is a unique one |
| | up | and valid. Accept the credit card details. Verify the credit card |
| | | credentials. Transact a $0.99 amount. Once all successful, |
| | | register the user in database. Send an email out to the parent |
| | | suggesting that he/she has signed up and also the kid's |
| | | credentials along with it. |
| RM-S3 (1) | Parent - Signing | A new screen to accept all the details for the child. The parent |
| | up Kids | will have an option of registering more than 1 child. The fees |
| | | would be $1 for any number of kids registered on the site. |
| RM-S4 | Child control | At the point of signing up the kid, the parent will select what |
| | feature | parameters can be displayed on the screen for the child. The |
| | | parent can also disallow the child from using the messaging |
| | | functionality or the Uploading of pictures. These will be marked |
| | | accordingly and controlled based on the child's user id. All the |
| | | parameters and functionalities will be allowed by default. |
| RM-S5 | Credit Card | Accept the credit card. Validate the credentials. Transact a |
| | validation | $1 fee. This is not a refundable amount. All this will be done at |
| | | the backend. This will be part of the parents sign up |
| | | functionality. |
| RM-S6 | Avatar Pic | The user will be able to upload a photograph which he/she wants |
| | | to be displayed as the Avatar pic. This will be a onetime upload |
| | | feature at the point of registration. The user can later change the |
| | | image via another screen option. This change is handled in the |
| | | photo Album management module. |

My Page:

| | Functional | Description | |
|---|---|---|---|
| Ref# | Requirements | (Requirement Details/Business Rules/validations.) | |
| MP-1 | Display | The following information will be displayed on the page: | |
| | personal | 1. | Avatar pic: The avatar picture uploaded by the user |
| | information | 2. | User name: The user name will be displayed |
| | | 3. | Location: Location of the user will be entered |
| | | 4. | Gender: Gender of the user |
| | | 5. | Birthday: Birth date of the user |
| | | 6. | School: School of the user |

| | | All the above information can be toggled on and off by the kids parents. It |
|---|---|---|
| | | will be displayed only if content is not toggled off by the parent. |
| MP-2 | Display other | The following information will also be displayed on the page: |
| | information | Invite friends |

| | |
|---|---|
| 1. | What am I upto: This information will be entered by the kid on |
| | the my page and can be edited as well |
| 2. | About me: This information will be entered by the kid on the my |
| | page and can be edited as well |
| 3. | My Mood: When a user registers a default my mood will be set. |
| | But the user can select from the list of available moods |
| 4. | User Photos: The list of photos will be displayed. A maximum of |
| | 8 photos will be displayed. These will be displayed on random |
| | basis. |
| 5. | Friend List: The list of user friends will be displayed. A |
| | maximum of 8 friends will be displayed. These will be displayed |
| | on random basis. |
| 6. | Secret message: This information will be entered by the user |
| 7. | My Lists: This information will be entered by the user |
| 8. | Instant message: All the messages sent by the friends will be |
| | displayed here along with the friend photo and friend user name. |
| 9. | My Tokens: The list of tokens registered by the user will be |
| | displayed |
| 10. | My Stats: The following information will be displayed: |

| | |
|---|---|
| a. | Tokens Givers rank: This will display the logged in users |
| | rank on the basis of how many chips he has given to his |
| | friends. |
| b. | Tokens Receiver rank: This will display the logged in users |
| | rank on the basis of how many chips he has received. |
| c. | Point Earners rank: This will display the logged in users rank |
| | on the basis of how many points he has earned till date. |
| d. | Individual point earning: This will display the total points |
| | earned by the logged in user. |

| | | |
|---|---|---|
| | | Item 1 to 8 can be toggled on and off by the Kids parent and will be |
| | | displayed on if it is toggled on. |
| MP-3 | Reporting My | Friends can report various my page contents for offensive content. |
| | Page content | A button will be provided on the UI, clicking on which will open a |
| | | notification pop-up which will have a list of issues, an appropriate source |
| | | and comments field. The list of issues will be constant, but source will |
| | | change based on the page from where the user is reporting. |
| | | Once the user clicks on Submit, a notification will be sent to the admin. |
| | | The admin can then see the content in the admin tool. In order to validate |
| | | the content, the admin will log out from the admin tool. Login to the front |
| | | end as wink, search for the offensive content on the users page and if |
| | | needed edit the content. |
| | | Once edited, the admin will login again to the admin tool and send |
| | | notification messages to the Kid and the parent. |
| | | If the admin finds the reported content to be non-offensive, he can clear |
| | | the flag for that content. |

Message Center:

| | Functional | Description |
|---|---|---|
| Ref# | Requirements | (Requirement Details/Business Rules/validations.) |
| MCM-I1 | Inbox | This will contain listing of all the messages received by user. Inbox page |
| | | will consist of following read only fields: |
| | | From: Displays name & Photograph of sender. Upon click direct |
| | | user to profile page of sender. |
| | | Subject: If received message doesn't have subject system will |
| | | display ‘No subject’ by default. |
| | | Received Date & Time. |
| | | There will be a delete option to delete selected mails. |
| | | View message: User can click on subject of individual message to view the |
| | | details of the message. These will consist of following read only details: |
| | | From: Displays name & photograph of the user. On click opens |
| | | Profile page of sender. |
| | | Date & Time |
| | | Subject |
| | | Message body. |
| | | User will see all the previous messages exchanges with the along with date |
| | | & time with first message appearing on top. |
| | | User will be directed to bottom of the message to reply textbox. |
| | | There will be two buttons: “Send” & “Cancel”. |
| | | On clicking ‘Send’, a message suggesting: “Your message has been |
| | | sent.” will be displayed. The sent message appears in message trail |
| | | above reply box. |
| | | On Clicking “Cancel” the message textbox is cleared & user is |
| | | taken back to previous page. |
| MCM- | Compose | A new blank message page opens where user can enter following details: |
| C1 | | To: |
| | | Subject: Optional |
| | | Message: Optional, RTF format |
| | | There will be two buttons: Send & Cancel |
| | | On clicking ‘Send’, a message displaying: “Your message has |
| | | been sent.” will appear on the screen. The system will display the |
| | | message trail with reply textbox in similar way as clicking on |
| | | View message link. |
| | | On clicking ‘Cancel’, the user will be redirected to the Inbox page. |
| MCM- | Sent | This will display all the messages sent by the user containing following |
| S1 | | details: To, Date & Message Body |
| | | A ‘Delete’ option will be available to the user to delete the sent mail. |
| | | Upon delete the system displays popup with message: |
| | | Are you sure you want to delete the message? |
| | | There will be two buttons on the popup - ‘Delete’ & ‘Cancel’. |
| | | On Clicking the ‘Delete’ option, the message will be deleted from the sent |
| | | items. |
| | | On clicking the ‘Cancel’ button, the Popup will disappear and the message |
| | | will remain in the ‘Sent’ items list. |

Instant Messages

| | Functional | Description |
|---|---|---|
| Ref# | Requirements | (Requirement Details/Business Rules/validations.) |
| CCM-1 | Instant messages | Users will be able to send Instant messages to friends. This |
| | | message will be shown on the friends my page along with the |
| | | sender name and photo. |
| | | Instant message will also be used as news feed. Update |
| | | messages will be sent on the following occasions. |

| | |
|---|---|
| a. | Whenever a friend updates their profile |
| b. | Whenever a friend uploads a new photo on my |
| | photos page |
| c. | Whenever a friend registers a new chip |

Photo Albums:

| | Functional | Description |
|---|---|---|
| Ref# | Requirements | (Requirement Details/Business Rules/validations.) |
| PM-P1 | Allow user to upload | The user would be allowed to upload the photos. The user can |
| | photos | also tag a photo with a description not exceeding 40 |
| | | characters. Validation will be in place to ensure the file type is |
| | | either of - .jpeg, .gif, .png format only. The file size will also |
| | | be validated against a limit of 2 MB. |
| PM-P2 | Edit Photos | The user will be able to change the title and description of the |
| | | photo. A photo can also be rotated through 90 degrees. The |
| | | edit option will also allow the user to delete a photo. |
| PM-P3 | Mark as Offensive | Only the buddies can view the photos and they can mark any |
| | | of the photos as offensive. |
| | | A button will be provided on the UI, clicking on which will |
| | | open a notification pop-up which will have a list of issues, an |
| | | appropriate source and comments field. The list of issues will |
| | | be constant, but source will change based on the page from |
| | | where the user is reporting. |
| | | Once the user clicks on Submit, a notification will be sent to |
| | | the admin. The admin can then see the content in the admin |
| | | tool |
| | | The administrator will be able to look into all such photos and |
| | | can decide on an appropriate action |
| | | A recycle bin will also be implemented. This bin will have all |
| | | the images deleted by the admin on the offensive photos page. |
| | | Sorting on publisher, reporter and date in offensive photos tab |
| | | Also notifications will be sent to Kids and parents when the |
| | | admin deletes a photo. |
| | | Photo deleted by the admin will not be shown on the site |
| PM-P4 | Image Sizes | All the images uploaded by the user will be resized into the |
| | | following: |

| | |
|---|---|
| For vertical | For horizontal |
| 354 × 530 | 530 × 398 |
| 160 × 160 | 160 × 160 |
| 65 × 65 | 65 × 65 |

| | | |
|---|---|---|
| | | Image magick will be used to do the resizing |
| PM-A1 | Create Album | The user can create an album. The album name has to be |
| | | unique for the user. |
| PM-A2 | Associate photos to the | The user can select already uploaded photographs to be part of |
| | album | an album or can load new photos which will be part of the |
| | | album. |
| PM-A3 | Disassociate photos | The user can remove a particular photo from the album. When |
| | | the user removes the photo, it will go in the individual photos |
| | | section. The photos will not be deleted. |
| PM-A4 | Delete Photo | The user can delete a particular photo from the album. On |
| | | deleting the photo, the photo gets permanently deleted from |
| | | the users collection. The related comments will also get |
| | | deleted. |

Manage Kids:

| | Functional | Description |
|---|---|---|
| Ref# | Requirements | (Requirement Details/Business Rules/validations.) |
| MK-1 | Manage Kids | Parents can manage their kids using this page. They will have |
| | | the option to add kids, activate accounts, freeze kid accounts |
| | | or delete kid accounts |
| MK-2 | Add Kids | Parents can register any number of kids from here. Clicking on |
| | | this link will open the register kid page. Parents will have to |
| | | fill in the required information and clicks submit, this will |
| | | register the kid and also activate the kid account. A message |
| | | will be sent to the Kids message inbox page welcoming him to |
| | | the site. |
| | | Parent will not be charged anything to register kids. Only a |
| | | onetime 1$ will be charged when a parent registers their first |
| | | kid. |
| MK-3 | Activate kids | A parent can activate kids who have been newly registered or |
| | | whose accounts have been frozen |
| MK-4 | Freeze kid accounts | When a parent does a freeze account the following will |
| | | happen: |

| | |
|---|---|
| a. | The kid account will become inactive, meaning the |
| | kid will not be able to login to the account. |
| b. | The Kid profile and photos will not be visible to any |
| | friends. |
| c. | The kid posted photo comments, Instant |
| | messages, Inbox messages will remain and be visible |
| | on the site. However the avatar picture for the kid |
| | will be displayed. |
| d. | A message will be sent to the FC admin saying the |
| | kid account is made inactive. |

| | | |
|---|---|---|
| | | A notification message will be sent to the admin |
| MK-5 | Delete Kid account | Delete kid will work as permanent delete: |

| | |
|---|---|
| a. | On permanent deletion all the data related to that Kid |
| | will be deleted from all the tables except the Chip |
| | transaction table. The kid will not be available on the |
| | site. |
| b. | In the Chip transaction table, the User name for the |
| | deleted kid will be replaced by “Deleted user” and |
| | the same will be shown on the UI as well. |
| c. | In a scenario where a kid(sender) has given a chip to |
| | another kid (receiver) and the receiver has not yet |
| | registered that chip. The sender gets deleted, the |
| | registered by in the Chip master table will be changed |
| | to “Deleted user” and then receiver will not be able to |
| | register that chip any more. An appropriate message |
| | will be shown to the receiver when he tries to register |
| | the chip |

Point System:

| | Functional | Description |
|---|---|---|
| Ref# | Requirements | (Requirement Details/Business Rules/validations.) |
| PS-1 | Accumulate points | Every time a kid performs an action (as mentioned in the excel |
| | | sheet) on the site a specific number of points will be |
| | | accumulated against his account. |
| PS-2 | Reward Frequency | All the actions performed on the site will be based on a certain |
| | | frequency as mentioned in the excel sheet available on SP. If a |
| | | kid performs an action the said number of times points will be |
| | | rewarded to him. |
| PS-3 | Admin tool controls | The admin will be able to manage these actions, in terms of |
| | | changing the points for these actions. Admin will not be |
| | | allowed to add/delete the actions for which points will be |
| | | rewarded |

Admin Tool

| | Functional | Description |
|---|---|---|
| Ref# | Requirements | (Requirement Details/Business Rules/validations.) |
| AM-C1 | Generate new | The administrator will need to provide the number of |
| | Tokens code | tokens to be generated, and the particular emoticon |
| | | associated with those tokens. |
| | | The system will generate random 9 alpha-numeric |
| | | character combination as tokens code |
| | | An option to export the list in an excel format will be |
| | | provided. |
| AM-C2 | Upload tokens photos | An option to upload tokens photos will be provided. |
| | | These photos will have to be in .jpeg or .gif formats. |
| | | These photos will form part of the tokens gallery |
| | | which all the site users can view. |
| AM-C3 | Delete tokens photos | An option to delete already uploaded tokens photos |
| | | will be provided. |
| AM-U1 | View Users | An option to view all existing users of the site |
| AM-U2 | Activate/Inactivate | An option will be provided to activate or inactivate a |
| | users | particular user. Inactive users cannot access the site. |
| | | Once activated, they can start using the site. |
| AM-U3 | Delete users | The administrator can delete users based on his/her |
| | | discretion. There will be 2 types of delete, Soft delete |
| | | (freeze account), Hard delete (Delete account) |
| | | Freeze account: |

| i. | The kid account will become inactive, meaning the |
|---|---|
| | kid will not be able to login to the account. |
| ii. | The Kid profile and photos will not be visible to any |
| | friends. |
| iii. | The kid posted photo comments, Instant |
| | messages, Inbox messages will remain and be |
| | visible on the site. However the avatar picture for |
| | the kid will be displayed. |
| iv. | A message will be sent to the FC admin saying the |
| | kid account is made inactive. |
| Delete account: | |
| v. | On permanent deletion all the data related to that Kid |
| | will be deleted from all the tables except the |
| | Chip transaction table. The kid will not be |
| | available on the site. |
| vi. | In the Chip transaction table, the User name for the |
| | deleted kid will be replaced by “Deleted user” |
| | and the same will be shown on the UI as well. |
| vii. | In a scenario where a kid (sender) has given a chip to |
| | another kid (receiver) and the receiver has not |
| | yet registered that chip. The sender gets deleted, |
| | the registered by in the Chip master table will be |
| | changed to “Deleted user” and then receiver will |
| | not be able to register that chip any more. An |
| | appropriate message will be shown to the |
| | receiver when he tries to register the chip |

| | | |
|---|---|---|
| AM-O1 | View Offensive | The administrator will be able to view a list of |
| | Content | content marked as offensive on the site by any user. |
| | | This includes details like Instant messages, inbox |
| | | messages, profile content, photos. |
| AM-O2 | Remove Offensive flag | The administrator can remove the offensive flag for |
| | for the content | the content. |
| AM-O3 | Delete offensive | The administrator can delete offensive photos. |
| | content | For modifying other content, the admin will login as |
| | | wink on the user side, navigate to the particular |
| | | problem area and edit the content. Once edited, the |
| | | admin will send notification messages to the kid and |
| | | parents. |
| AM-M1 | Receive messages | Whenever a user marks a content as offensive, a |
| | | message will be received by the administrator |
| AM-M2 | Send messages | The administrator can send out messages to the users |
| | | of the site. |
| | | For default notification messages the admin will have |
| | | the option to edit the default content before sending it |
| | | to kids or parents |
| AM-F1 | File upload | The administrator will have an option to upload xml |
| | | files which will be used to control the themes |
| AM-SC1 | Static Content | The static content will be stored in database as a free |
| | | flowing text |
| | | The administrator will have an option of changing/ |
| | | editing this information. |
| AM-R1 | Reports | All reports will be in the tabular form. |
| AM-PS1 | Manage Points system | The admin will be able to manage these actions, in terms of |
| | | changing the points for these actions. Admin will not be |
| | | allowed to add/delete the actions for which points will be |
| | | rewarded |

3.2. Business Events

Payment processing would be done through a payment gateway.

### 4. External Interface Requirements

| Req # | Requirement | Description | External System(s) |
|---|---|---|---|
| RM-S6 | Credit card | Transact through | Payment Gateway |
| | transaction | payment gateway. | |

### 5. Operating Environment Requirements

5.1. Hardware

Pentium based server with 1 GB RAM and 4 GB of disk space

5.2. Software

Java, MySQL, Image magick.

5.3. Network

Minimum 128 Kbps

5.4. Communication

The site would be accessed using a web browser. Any special communication requirements for the payment gateway will be required.

### 6. Performance Requirements

| Req # | Performance Requirement | Description | External System(s) |
|---|---|---|---|
| RM-S1 | Less than 5 seconds | The message of a successful sign | Network connectivity |
| | | up or an error message otherwise | |
| | | would be displayed. | |
| RM-S2 | Less than 10 seconds | The message of a successful | Network Connectivity |
| | | registration or an error message | |
| | | otherwise would be displayed | |
| RM-S3 | Less than 20 seconds | The message of a successful | Network connectivy, Payment |
| | | registration or an error message | Gateway connectivity |
| | | otherwise would be displayed | |
| PM-P1 | Less than 5 seconds | The entire process of uploading a | Network connectivity |
| | | new photo should take less than 5 | |
| | | seconds | |
| PM-A1 | Less than 5 seconds | Creation of a new album should | Network Connectivity |
| | | not take more than 5 seconds | |
| MCM-I1 | Less than 5 seconds | The Inbox should be populated in | Network connectivity |
| | | less than 5 seconds from the time | |
| | | the user clicks the ‘Inbox’ option. | |
| | | If the user wants a view a | |
| | | particular message, the message | |
| | | should open up in less than 5 | |
| | | seconds too. | |
| MCM-C1 | Less than 2 seconds | A new blank message page should | Network Connectivity |
| | | appear within 2 seconds of the user | |
| | | clicking the ‘Compose’ option | |
| MCM-S1 | Less than 5 seconds | The entire list of sent items should | Network connectivity |
| | | appear on the screen | |

Detailed Description—External Social Collecting Network Geared to Users of all Ages

The Entertainment System to create a online social network for collectors (of all ages) of special tokens with registration codes that are linked to a computer database, to exhibit their collections virtually and to socialize with other collectors who shared similar interests, would be powered by a social network engine that would operate as an open or “external social network” (ESN). An ESN is open/public and available to all web users.

Unlike other ESN's, this network for collectors (of all ages) of special tokens would be a specialized community that would be focused on trading the theme represented by the tokens, i.e. sports, (but not limited to sports, wherein other examples of collecting communities that could utilize such an invention as described here are car collectors; model train collectors; animal conservationists/observers i.e. bird watchers, comic character collectors, movie film goers, etc.) Collectors, fans and enthusiasts would purchase and trade sports themed tokens to create offline and virtual online rosters of their favorite teams and players.

This method of creating collectable tokens with registration codes that are linked to a computer database would apply to all competitive sports; both professional and amateur sports, Olympic sports, sports not listed here and sports yet to be created. Examples of sports that would be featured on the tokens would be: Air Racing, Arm Wrestling, Auto Racing, Baseball, Basketball, Bodybuilding, Bowling, Boxing, Card Games, Cheerleading, Cricket, Cycling, European Football (aka soccer), Extreme Sports, Fishing, Football, Golf, Grappling, Gymnastics, Horse Racing, Hunting, Ice Hockey, Ice Staking, Lacrosse, Lumberjacking, Motorboat Racing, Motorcycle Racing, Polo, Rodeo Riding, Rugby, Sailing, Skateboarding, Skiing, Snowboarding, Surfing, Tennis, Ultimate Fighting, Video Gaming, Volleyball, Weightlifting, and Wrestling.

Each sporting season new editions of tokens would be released representing the players on a particular team's active roster. The business model would be monetized on the sale of a physical product—sports trading tokens linked to an online website. The website would be offered as a “value add”—registration would be free and there would be no subscription fees.

Users of the Entertainment System would go online via a computer hooked up to the Internet and register each token to their personal online account. Once the code was verified by the online database, a virtual facsimile of the token would appear on a special page where other virtual tokens of players from the same sports team were displayed. The method or “goal” of the system would be to collect all the players on a particular team.

Sporting themed tokens for the Entertainment System would feature, but would not be limited to individual players (current and retired), Most Valuable Players (MVP's), rookie players, championship game tokens, playoff series tokens, race vehicle tokens and venue tokens. New editions of these sporting themed tokens would be issued for each new season.

The Method used would be for the intended user: a collector, fan or enthusiast to purchase special silver dollar-sized sports themed tokens, featuring player's photographs or team insignias on the “head” side of the token. The “tail” side (back) of each token would feature the player's name, position, player number, team, team logo, league logo (i.e. the Major League Baseball (MLB) logo). Additionally a series of unique alpha-numeric serial numbers would be stamped or printed, laminated, silkscreened, or lasered onto the tail side as well.

The code could also be displayed as a “Bar Code,” an optical machine-readable representation of the data. Another way in which the code would be accessed is via a passive Radio-frequency identification (RFID) chip implanted within the token.

(An RFID is a computer chip capable of creating a signal transmission that can be tracked using radio waves. Passive RFID tags, which have no battery, require an external source to provoke signal transmission.) These two methods would require the user to have a Bar Code or RFID read connected to their computer. The use of such technology would eliminate the need for users to manually input codes and make for a more desirable user experience. The sale of such devices would generate additional revenue for the business venture.

The website URL address would also be printed on the rolling side of the token. An example of such a system and method is detailed in Exhibit 9: SportsChipz and FootballChipz Token Designs.

Each token would be assigned a particular value. The point value could be arbitrary, based on the featured player's current statistical scoring record, or based on the number of tokens produced—the lesser number available the greater the value of the token.

The more tokens users collected, the more points they would accumulate. Earned points would then be used for a variety of things: to acquire enhanced feature modules, special background themes, audio/video content. Points would also be used to “pay” for online games and for acquiring special virtual tokens which would only be available online to registered users. Such a token would resemble the branded physical tokens in size and format, but instead of just featuring a static image—these virtual tokens might feature video clips or possibly be in 3D. An example of a baseball themed virtual token might be a talking, three-dimensional representation of a famous World Series pitcher. Another example of a football themed virtual token would be a “razzer” token that would be a given by a user to a fan of a rival team. “Opening” the virtual razzer the Recipient would be greeted by the rival team's mascot “blowing a raspberry,” a noise signifying derision and/or silliness, made by sticking out the tongue between the lips and blowing to make a sound reminiscent of flatulence. Such taunts are enjoyed by rival fans who greatly appreciate such an added service feature.

Each user of the web platform would have their own customizable profile page. Such a page would feature all the sports and teams the user followed/collected. Some of the features of the Profile Page would be a sports news chaser module, a Team Tracker module, a Roster Update module, a Favorite Play (token) module, A Number of Daily Trades module, a list of other users currently online, a Mobile Trading module. In addition the user would be able to post comments, upload a Profile Picture or post an avatar, upload personal images and audio/video. The user would also have the ability to post their contact information, such as email address, and phone number. Also included would be the number of other site users who viewed the users profile, number of blog posts, number of collectors in the user's network, and special online user groups.

Other feature modules contained on the user's profile page would include personal information about the user such as: Current location, Hometown, Gender, Age, Predictions, Favorite Sports Moments, Favorite Sports Movies, Favorite Sports TV Shows, Favorite Sports, Favorite Athletes, Favorite Teams, Favorite Sports Plays, Memorable Personal Sports Achievements, Favorite Sports Websites, Favorite Sports Bloopers, Favorite Mascots, Favorite Cheerleading Squads, Favorite Sports Quotes, and how long the user has been a member of the website.

Users would also be able to upload custom applications (“apps”) or “widgets” to their profile pages. (A widget is a portable chunk of code that can be installed and executed within any separate HTML-based web page by an end user without requiring additional compilation. They are derived from the idea of code reuse. Such widgets often take the form of on-screen tools (clocks, event countdowns, auction-tickers, stock market tickers, flight arrival information, daily weather etc). An example of sports themed widget that would be featured on this particular Entertainment System would be a league standings update module. Some of these applications would be sponsored and provide the operator of the web service with additional revenue.

The code for creating such applications would be made available to all interested parties that were interested in developing applications for web services directed at sports enthusiasts. The Entertainment System would deploy and “Open Source” approach to the design, development, and distribution of software which would offer practical accessibility to system's software source code.

In addition to the user's profile page, the Entertainment System would feature but not be limited to individual Sport (web) Pages, e.g., baseball, ice hockey, basketball, football, car racing; Individual Team Pages, and Individual Player Pages. Each of these web pages would feature statistical information about the team and its players. This information would be automatically updated via a live statistical reporting service that the Web Service would contract with. The web pages would feature images and audio/video about particular teams and individual players. Additionally the individual player's pages would feature specific up to date statics about the player as well as personal data and trivia. Also, a virtual representation of the player's trading token would be featured.

The web service would also feature a section where users of the website would trade with other users duplicate tokens they collected. This part of the site would be called the Trading Zone. If a user got a token for a player or a team that they were not interested in owning they would post it in the particular team's Trading Zone. That would send an alert out to all other collectors apprising them that a certain player in the user's roster was available for trade. After a trade was completed, the new owner of the token would go online, re-register the code to their profile and take ownership of the (token) player. Previous token holders could opt to have identities cloaked from subsequent owners—thus maintaining the privacy of the immediate trader, or they could allow their identities to be posted.

Additionally promotional tokens would be made available to users of the system. These tokens would be custom made with a sponsor's logo or artwork on them. Similar to sponsored “Bat Days” or “rally towel nights,” an advertiser might sponsor an online sporting token give-away night at a baseball game. Fans attending a racing circuit such as one staged by the National Association for Stock Car Auto Racing (NASCAR) might receive a different token for each race of the season. This method would create collectability for the tokens and encourage fans who wanted to collect all the entire season's tokens to attend consecutive race events. Normally after such an event was over, a sponsored trinket would be discarded or forgotten; however online collectable tokens would begin a second life when fans took them home and registered them online.

The promotional tokens would have a code that was preregistered to a special themed web page/microsite created especially for the sponsor. Users would register these promotional tokens to their profile. In the process they would be awarded a certain number of points to spend on the sponsor's special microsite (Also known as a minisite or weblet, the microsite is an Internet web design term referring to an individual web page or cluster of pages which are meant to function as an auxiliary supplement to a primary website.) These microsites would reside within the main online domain and could only be accessed by registered users who have accepted and registered a sponsor's token. Each promotional “microsite” would be unique and contain custom applications such as virtual goods, games, downloads and sweepstakes. The sponsor would advertise their products on the microsite, and be able to send certain messaging to users that registered the promotional tokens. This virtual “connection” between fan and sponsor would continue well beyond the date the initial token was acquired—thus creating a long term relationship between the advertiser and the consumer.

Additionally these promotional tokens would be offered as “in-store,” promotions (handed out during “check out” to customers purchasing of a sponsor's product), “on-pack” promotions (directly attached to a product), and “in-box” promotions (i.e. inside a cereal box). These promotional token sponsorship programs would provide the operator of the web service with additional revenue.

Some of the features of the current embodiment include the option to offer various accessories, and/or services to the user. Examples of these accessories would be digital code readers, published collector's guidebooks, token collection display units, tokens carrying cases, branded apparel, as well as branded food products. These accessories would provide the user of the service with a value-added experience and the operator of the web service with additional revenue.

Below is an outline for the basic entertainment system (described above) that would support an external social network propagated through the exchange of collectable sports theme tokens by users of all ages:

1. The following entertainment systems would be included in the website:
a. A Registration module would “sign up” users to the site.
   i. Registration would require the user to create a username and password. It would also ask for the individual's birthday to confirm that the user was old enough to use the site (16 years of age). The system would ask the user to check a box confirming that they had read the “term and conditions” regarding use of the site.
   ii. Use of the website would free.
b. Profile fields would specify the user's name, date of birth and certain personal preferences
   i. Avatar photo uploading would enable a user to post a profile picture.
   ii. The user would have the ability to post their personal contact information, such as email address, and phone number. Also included would be the number of other site users who viewed the users profile, number of blog posts, number of collectors in the user's network, and special online user groups.
   iii. Additional information contained on the user's profile page would include: Current location, Hometown, Gender, Age, Predictions, Favorite Sports Moments, Favorite Sports Movies, Favorite Sports TV Shows, Favorite Sports, Favorite Athletes, Favorite Teams, Favorite Sports Plays, Memorable Personal Sports Achievements, Favorite Sports Websites, Favorite Sports Blooper, Favorite Mascots, Favorite Cheerleading Squad, Favorite Sports Quotes, and how long the user has been a member of the website.
   iv. Avatar photo editing would enable users to crop, rotate and edit their photo(s).
c. The user's main “Home Page” would feature all the sports and teams they followed/collected.
   i. Additional features would include: a sports news chaser module, a Team Tracker module, a Roster Update module, a Number of Daily Trades module, a list of other users currently online, a Mobile Trading module.
   ii. In addition the user would be able to post comments, upload a Profile Picture or post an avatar, upload personal images and audio/video.
d. The Site would also feature a main home landing page where users could view and access links to all the sports teams and players and leagues that were collectable via the online service.
e. A computer database would support all competitive sports; both professional and amateur sports, Olympic sports, sports not listed here and sports yet to be created.
   i. Examples of sports that would be featured on the tokens would be: Air Racing, Arm Wrestling, Auto Racing, Baseball, Basketball, Bodybuilding, Bowling, Boxing, Card Games, Cheerleading, Cricket, Cycling, European Football (aka soccer), Extreme Sports, Fishing, Football, Golf, Grappling, Gymnastics, Horse Racing, Hunting, Ice Hockey, Ice Staking, Lacrosse, Lumberjacking, Motorboat Racing, Motorcycle Racing, Polo, Rodeo Riding, Rugby, Sailing, Skateboarding, Skiing, Snowboarding, Surfing, Tennis, Ultimate Fighting, Video Gaming, Volleyball, Weightlifting, and Wrestling.
   ii. Links from each of these teams or sports would take users to both current and past team rosters featured on the web service. Further links would also take users to view individual athletes featured web pages on the web service.
f. A Token Database Administration would feature:
   i. A Database Management System would allow the administrator to manage (create/edit/delete/retire) a list of tokens including name (i.e. player name), player position number, player position, team captain status, point value, image, and particular information about the token such as: color scheme, release date, biographical data and trivia. These including the associated list of friend codes would be uploaded as Comma separated values “CSV;” (A CSV file is used for the digital storage of data structured in a table of lists form, where each associated item (member) in a group is in association with others also separated by the commas of its set.). Friend codes would include a list of unique codes that are available for a purchaser to enter as part of friending process).
   iv. The Code Management System would need to support a large number of token codes in the tens of millions. Such number generation and management software would need to be capable of generating millions of numbers and keeping track of them, so they do not repeat. Additionally the software would also need to cross-reference token colors, designs and other pertinent information. The database administrator would need to be able to be export this data as CSV/Excel files that would be given manufacturers producing the tokens.
   i. Each sporting season new editions of tokens would be released representing the players on a particular team's active roster. Virtual representations of these tokens would be viewable on the website
a. A Token Registration System would be featured:
   ii. Token Registration: token purchaser registration of code for items purchased
   iii. Token Trading: enabling the trading/exchanging of tokens between users
   iv. Adding linked users to each other's friend/contact list
   v. A “Feed,” a data format used for providing users with frequently updated content, would list when a token is confirmed to have been traded from one user to another
b. A Tokens collected module would display a list of total tokens collected along with image and number of each. This would be linked to from the user's personal homepage.
c. A Tokens Traded module would list tokens traded including individuals they traded the tokens with. This would be linked to from the user's personal homepage.
d. A Tokens List module would display a public list of tokens a user has collected. This would be linked to from the user's personal homepage.
e. A Tokens Gallery module would be created to show all tokens in the system created by administrator (minus “retired” tokens), placed on a standalone page, which could be browsed. Each token's name and image and pertinent data would be listed.
f. Token usage analytics would include:
   vi. Number of tokens registered
   vii. Number of tokens traded
   viii. Regions, where tokens were purchased
   ix. Age of token purchaser—ranges, averages

2. The following entertainment systems would also be included:
a. Inbox for private messages
b. Privacy settings would enable users to set all or parts of their profile as “Public” or “Private.”
c. A Photo gallery would include tags, comments, and privacy alert controls
d. A Video gallery would include tags, comments, and privacy controls
e. A Notes application blogging functionality would include the ability to publish an internal blog
f. A Groups application would enable the aggregation of user groups
g. An Events application would help users keep track of calendared events, such as regularly scheduled league play and playoff games. It would also enable users to keep track of games they attended, favorite player's birthdays and their fellow user's birthdays.
h. A Media Posting Gallery application would enable the posting and viewing of videos and audio files.
i. A Feed would update users on their friends’ activities, i.e. tokens added, profile pictures changed, and virtual gifts received.
j. A messaging system would feature a profile commenting system
k. A Create Your Own Token Module would also be made available for users of the system.
   i. The system would access a live web camera connected to the user's computer to take a photograph of themselves or use an existing image (which could be edited/manipulated in fun ways) and then printed out onto a sheet of round stickers that could be placed into special tokens and given out to friends.
l. A My Friends Module would display other users on the site
   i. The module would identify cohorts that the signed-on user had traded with or where in his friendship circle—these social mappings would be viewable/sortable by: user identified cohort cliques, users who follow the same favorite player, users who follow the same favorite team, users who follow the same hometown team, and other fan/user preferences
   ii. The module would feature a “search” option to find other users on the site.
m. Mobile: a Short Message System (SMS) and mobile version would be also be deployed
n. Networks/Groups would be created around sports, teams or region that would allow select users to join, i.e. a Fans of Derek Teeter group.
o. A Virtual Goods Module would enable users to buy, gift and display virtual sports tokens.
   i. The platform would feature a store where users could preview “virtual tokens” and then purchase them using points they had earned from collecting the physical tokens.
   ii. Users would have the option to buy the goods for themselves or send them as a gift to another user. Additionally there would also be virtual “razz” items that would be sent between fans of rival teams to taunt each other. An example of this would be a New York Yankees baseball fan sending an “Evil Empire” virtual token to a rival Boston Red Socks fan.
      1. An online payment gateway would enable site users to purchase additional points (that could only be spent online) to acquire virtual goods. These purchased points would supplement existing points users accrued by collecting and registering physical tokens.
   iii. A virtual Gallery would feature all the virtual goods acquired by a user. (The user could opt to have certain virtual goods publicly or privately viewed)
p. A My Tokens widget would syndicate users' tokens to other websites
q. A token voting system would be created to determine popularity of the tokens
r. The hosting environment for the platform would provide multi-server, load balanced configurations
s. User data and metrics
   i. A server side usage reporting package would provide analytics
t. Homepage Management—the system would be designed to include the ability for the network operator to:
   i. Control module placement on left, right margins
   ii. Create an announcements module
   iii. Reskin site through changing theme including background image, site colors, etc. Users would be able to select their favorite teams' color and “wallpaper,” they could also choose certain audio tracks to play when a page opened—an example of this would be having “take me out to the ball game” play when the user visited the baseball part of the website, or the famous “Gipper” speech play when visiting the Notre Dame college football website.
   iv. Cascading Style Sheets (CSS) would be editable by the network operator.

Although the invention has been described in considerable detail in language specific to structural features and or method acts, it is to be understood that the invention defined in the appended claims is not necessarily limited to the specific features or acts described. Rather, the specific features and acts are disclosed as preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

In addition, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of,” “act of,” “operation of,” or “operational act of in the claims herein is not intended to invoke the provisions of 35 U.S.C. 112, Paragraph 6.

What is claimed is:

1. A system for collectable medium, comprising:
a collectable medium with a unique identification; and
a collectable computer networking system that includes a database that identifies and associates the unique collectable medium exclusively with a specific user.

2. The system for collectable medium as set forth in claim 1, wherein:
the collectable medium is one of a physical and virtual collectable medium.

3. The system for collectable medium as set forth in claim 1, wherein:
the collectable medium, includes:
unique identification mechanism that exclusively identifies the collectable medium; and
content.

4. The system for collectable medium as set forth in claim 3, wherein:
the collectable medium includes physical characteristic commensurate with collectable interest.

5. The system for collectable medium as set forth in claim 3, wherein:
the content includes:
media related to a collectable interest;
media related to brand association and marketing,
statistical data related to the collectable interest;
Uniform Resource Locator (URL) of the system.

6. The system for collectable medium as set forth in claim 4, wherein:
the statistical data, includes:
information related to subject matter of collectable interest.

7. The system for collectable medium as set forth in claim 1, wherein:
the collectable computer networking system is an online network of cohorts, which also includes individuals that posses collectable medium.

8. The system for collectable medium as set forth in claim 7, wherein:
the cohorts associate the collectable medium with the collectable computer networking system by registration, including entry of the unique identification of the collectable medium within the system database.

9. The system for collectable medium as set forth in claim 8, wherein:
the collectable computer networking system provides incentives to register a collectable medium.

10. The system for collectable medium as set forth in claim 8, wherein:
the collectable medium is assigned a set of redeemable points as incentive to acquire additional collectable medium, virtual collectables, and other items of interest.

11. The system for collectable medium as set forth in claim 8, wherein:
the collectable computer networking system, includes:
various navigational tools to enable a user to link and network with cohorts, including:
a collectable medium display section for displaying a set of collectable medium of a cohort;
a User Profile section link;
Roster Update section that provides updated information for the subject of interest;
a Favorites section that lists the favorite collectable medium by subject of interest;
a Ranking section for ranking cohorts collections and standing within the collectable computer networking system;
Network statistical sections for total number of online users and trades of the collectable medium;
a Real-Time Instant Messaging System for cohorts that are online, including an internal email system;
links to a wireless mobile system for additional connectivity;
Live News Ticker related to subject of interest;
Advertising section;
mechanism for invitation of non-registered users;
links to sources for the collectable medium; and
links to external URL.

12. The system for collectable medium as set forth in claim 11, wherein:
a User Profile section includes:
an informational tote board that displays trading and acquisition of collectable medium within the collectable computer networking system by user and user cohorts; and
cohort affinity for subsets of collectable medium, and links that enable a user to access the cohort.

13. The system for collectable medium as set forth in claim 12, further includes:
a display of a subset of the collectable mediums of subject of interest, which facilitates the user to determine the completeness of the set;
includes a system message that promotes and incentivizes the addition of collectable medium to complete a full set;
navigational bar that enables users to navigate through the collectable computer networking system for addition and trade of collectable medium, including view of larger subsets of subject of interest and other cohorts with similar interests; and
the ranking subsection for ranking cohorts collections and standing within the collectable computer networking system for a particular set of collectable medium related to a specific subject of interest.

14. The system for collectable medium as set forth in claim 13, wherein:
selection of an individual collectable medium from the subset of collectable medium displays further detailed information related to the selected individual collectable medium, including the unique identifier and content.

15. The system for collectable medium as set forth in claim 14, further including:
a chain of title of ownership of the selected collectable medium, with individual cohorts within the chain of title optionally remaining private.

16. The system for collectable medium as set forth in claim 15, further includes:
a fully integrated trading mechanism that enables users to post collectable medium for trading, including:
an audio-visual display of the collectable medium that enables a trader to informatively select and trade off collectable medium internally within the collectable computer networking system.

17. The system for collectable medium as set forth in claim 15, further includes:
an alert mechanism notifying interested cohorts of a trade to participate in appraisal and trade of a particular collectable medium.

18. The system for collectable medium as set forth in claim 10, wherein:
the virtual collectables include:
amusement disrupters that are forwarded to cohorts for disrupting online viewing experience of a receiving cohort.

19. The system for collectable medium as set forth in claim 2, wherein:
virtual collectable medium is a representation of a physical collectable article.

20. The system for collectable medium as set forth in claim 1, wherein:
the collectable medium is provided to participating cohorts of an event by a sponsor to establish a relationship with cohorts.

21. The system for collectable medium as set forth in claim 20, wherein:
the established relationship is comprised of incentives for the cohorts to register the provided collectable medium with the collectable computer networking system, and attend further sponsored events to complete a set of the collectable medium.

22. The system for collectable medium as set forth in claim 1, wherein:
the collectable medium is provided to individual as a purchase incentive by sponsors.

23. The system for collectable medium as set forth in claim 1, wherein:
the collectable medium is purchased by an individual.

24. The system for collectable medium as set forth in claim 1, wherein:
cohorts engage in online virtual games with rewards in terms of additional points that may be used within the system, with games themed around cohorts' affinities.
